(19) United States
(12) Patent Application Publication
(10) Pub. No.: US 2026/0267188 A1
(43) Pub. Date: Sep. 10, 2026

(54) LIQUID CRYSTAL DISPLAY PANEL AND DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Ce WANG, Beijing (CN); Yao BI, Beijing (CN); Longhu HAO, Beijing (CN); Xian WANG, Beijing (CN); Haoran ZHANG, Beijing (CN); Ning LI, Beijing (CN); Bangjun SONG, Beijing (CN); Donghua ZHANG, Beijing (CN); Kangdi ZHOU, Beijing (CN); Yong ZHANG, Beijing (CN); Hongjun YU, Beijing (CN); Yashuai AN, Beijing (CN); Yang GE, Beijing (CN); Lei SHI, Beijing (CN); Xingxing GUAN, Beijing (CN); Jianwei MA, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 18/994,190

(22) PCT Filed: Aug. 31, 2023
(86) PCT No.: PCT/CN2023/116080

§ 371 Date: Jan. 14, 2025

(51) Int. Cl. G02F 1/1339; G02F 1/1333; G02F 1/1335; G02F 1/1337; G02F 1/1362

(52) U.S. Cl. CPC G02F 1/1339; G02F 1/133368; G02F 1/133388; G02F 1/133512; G02F 1/133514; G02F 1/1337; G02F 1/136204; G02F 1/136286

(57) ABSTRACT

A liquid crystal display panel and a display device. The liquid crystal display panel includes an array substrate and an opposite substrate opposite to each other, and a liquid crystal layer disposed therebetween, wherein the array substrate includes pixel structures located on a first base substrate, the opposite substrate includes a second base substrate and an anti-overflow structure which is disposed on a side of the second base substrate facing the array substrate, and configured to prevent liquid crystal in the liquid crystal layer from overflowing. The liquid crystal display panel includes a display region and a peripheral region surrounding the display region, and further includes a frame sealing adhesive located in the peripheral region and between the array substrate and the opposite substrate, and the anti-overflow structure surrounds the display region and is disposed on a side of the frame sealing adhesive close to the display region.

### TECHNICAL FIELD

The present disclosure relates to a liquid crystal display panel and a display device.

### BACKGROUND

In the field of display technology, liquid crystal display (LCD) has the advantages of light weight, thinness, low power consumption, high brightness and high image quality.

Generally, a thin film transistor liquid crystal display includes an array substrate, an opposite substrate, a liquid crystal layer sandwiched between the array substrate and the opposite substrate, and a frame sealing adhesive for bonding the outer edges of the array substrate and the opposite substrate. The thin film transistor liquid crystal display can change the orientation of liquid crystal molecules in the liquid crystal layer by changing the electric field intensity across the liquid layer between the array substrate and the opposite substrate, so as to control the intensity of light transmission and realize the display of images.

In recent years, the trend of miniaturization of display screens has become increasingly obvious, and small screens below one inch are widely used in application scenarios such as scanning pens, electronic cigarettes, knobs, or the like. On the premise of low cost, the thin film transistor liquid crystal display can meet the requirements of updating iteration of small screen products and improving the display effect of products.

### SUMMARY

In order to solve the problem of abnormal cell-assembling caused by liquid crystal droplet diffusion in a miniaturized liquid crystal display panel, the embodiment of the present disclosure provides a liquid crystal display panel. An opposite substrate of the liquid crystal display panel is provided with an anti-overflow structure, which can prevent the liquid crystal from overflowing, avoid the liquid crystal from diffusing to the boundary of the frame sealing adhesive, and further buffer the impact of the liquid crystal droplet on the frame sealing adhesive, solve the puncture problem and improve the yield of products.

At least one embodiment of the present disclosure provides a liquid crystal display panel, including an array substrate and an opposite substrate dispose opposite to each other, and a liquid crystal layer disposed between the array substrate and the opposite substrate, wherein the array substrate includes a first base substrate and a plurality of pixel structures located on the first base substrate, the opposite substrate includes: a second base substrate; and an anti-overflow structure, disposed on a side of the second base substrate facing the array substrate, and configured to prevent liquid crystal in the liquid crystal layer from overflowing, wherein the liquid crystal display panel includes a display region and a peripheral region surrounding the display region, and further includes a frame sealing adhesive located in the peripheral region and disposed between the array substrate and the opposite substrate, and the anti-overflow structure surrounds the display region and is disposed on a side of the frame sealing adhesive close to the display region.

For example, in the liquid crystal display panel provided by an embodiment of the present disclosure, a maximum dimension of the display region of the liquid crystal display panel in a plane parallel to the second base substrate is less than or equal to 30 mm.

For example, in the liquid crystal display panel provided by an embodiment of the present disclosure, in a plane parallel to the second base substrate, a distance between the anti-overflow structure and the display region is in a range from 100 μm to 300 μm, a distance between the anti-overflow structure and the frame sealing adhesive is in a range from 100 μm to 300 μm.

For example, in the liquid crystal display panel provided by an embodiment of the present disclosure, the opposite substrate further includes a spacer, and the spacer is located in the display region and disposed on a side of the second base substrate facing the array substrate, the anti-overflow structure is configured to be formed by a same material and a same patterning process as the spacer.

For example, in the liquid crystal display panel provided by an embodiment of the present disclosure, the anti-overflow structure includes at least one anti-overflow cofferdam.

For example, in the liquid crystal display panel provided by an embodiment of the present disclosure, a shape of the anti-overflow cofferdam in a plane parallel to the second base substrate includes a polygon, and the anti-overflow cofferdam includes a plurality of notches.

For example, in the liquid crystal display panel provided by an embodiment of the present disclosure, an anti-overflow cofferdam of the at least one anti-overflow cofferdam includes a notch, the opposite substrate further includes an alignment layer, and the alignment layer is disposed on a side of the second base substrate facing the array substrate and has an alignment direction, the notch is located at a position of the anti-overflow cofferdam farthest from a center line passing through a center of the display region and along the alignment direction.

For example, in the liquid crystal display panel provided by an embodiment of the present disclosure, the at least one anti-overflow cofferdam includes: a first anti-overflow cofferdam, including a first opening; and a second anti-overflow cofferdam, including a second opening, wherein the first opening and the second opening are opposite to each other, and the first anti-overflow cofferdam and the second anti-overflow cofferdam have an overlapping region in which the first anti-overflow cofferdam and the second anti-overflow cofferdam are arranged at intervals to form a channel.

For example, in the liquid crystal display panel provided by an embodiment of the present disclosure, the opposite substrate further includes an alignment layer, the alignment layer is disposed on a side of the second base substrate facing the array substrate and has an alignment direction, the overlapping region is disposed on a position of the anti-overflow cofferdam farthest from a center line passing through a center of the display region and along the alignment direction.

For example, in the liquid crystal display panel provided by an embodiment of the present disclosure, the first anti-overflow cofferdam includes a first sub-portion and a second sub-portion arranged opposite to each other, and a first connection portion connecting the first sub-portion and the second sub-portion, and the second anti-overflow cofferdam includes a third sub-portion and a fourth sub-portion arranged opposite to each other, and a second connection portion connecting the third sub-portion and the fourth sub-portion, the first sub-portion and the third sub-portion have an overlapping region and are arranged at intervals to form a channel, and the second sub-portion and the fourth sub-portion have an overlapping region and are arranged at intervals to form a channel.

For example, in the liquid crystal display panel provided by an embodiment of the present disclosure, an anti-overflow cofferdam of the at least one anti-overflow cofferdam includes a plurality of first anti-overflow portions and a plurality of second anti-overflow portions, and a dimension of each of the plurality of first anti-overflow portions is larger than a dimension of each of the plurality of second anti-overflow portions in a direction perpendicular to the second base substrate, in an extending direction of the anti-overflow cofferdam, the plurality of first anti-overflow portions and the plurality of second anti-overflow portions are alternately arranged.

For example, in the liquid crystal display panel provided by an embodiment of the present disclosure, in a direction perpendicular to the second base substrate, a difference between a height of each of the plurality of first anti-overflow portions and a height of each of the plurality of second anti-overflow portions is in a range from 0.5 μm to 0.65 μm.

For example, in the liquid crystal display panel provided by an embodiment of the present disclosure, the opposite substrate further includes a planarization layer, the planarization layer is disposed on a side of the second base substrate facing the array substrate, and the anti-overflow structure includes at least one anti-overflow groove formed in the planarization layer and recessed toward the second base substrate.

For example, in the liquid crystal display panel provided by an embodiment of the present disclosure, a depth of an anti-overflow groove of the at least one anti-overflow groove is in a range from 0.5 μm to 1.5 μm, and a width of the anti-overflow groove is in a range from 200 μm to 400 μm.

For example, in the liquid crystal display panel provided by an embodiment of the present disclosure, the opposite substrate further includes: an electrostatic discharge layer, disposed on a side of the second base substrate facing the array substrate, wherein the frame sealing adhesive is at least partially connected with the electrostatic discharge layer, and the frame sealing adhesive is configured to have conductivity so that the electrostatic discharge layer is connected with the array substrate through the frame sealing adhesive.

For example, in the liquid crystal display panel provided by an embodiment of the present disclosure, the array substrate further includes a common electrode layer, disposed on a side of the first base substrate facing the opposite substrate, the common electrode layer includes a common electrode located in the display region and a conductive structure located in the peripheral region, and the frame sealing adhesive is at least partially connected with the conductive structure.

For example, in the liquid crystal display panel provided by an embodiment of the present disclosure, the array substrate further includes a first common electrode line surrounding the display region and a second common electrode line surrounding the first common electrode line, the first common electrode line is connected with the second common electrode line, the first common electrode line is connected with the common electrode, and the second common electrode line is connected with a signal input port of the liquid crystal display panel, the array substrate further includes a via hole, and the second common electrode line is connected to the conductive structure through the via hole.

For example, in the liquid crystal display panel provided by an embodiment of the present disclosure, an orthogonal projection of the frame sealing adhesive on the first base substrate at least partially overlaps with an orthogonal projection of the second common electrode line on the first base substrate, the second common electrode line includes a metal grid line.

For example, in the liquid crystal display panel provided by an embodiment of the present disclosure, the array substrate further includes a first common electrode line surrounding the display region and a second common electrode line surrounding the first common electrode line, the first common electrode line is connected with the second common electrode line and connected with the common electrode of the display region, the second common electrode line is connected to a first signal input port of the liquid crystal display panel to be supplied with a first voltage signal, the conductive structure is connected to a second signal input port of the liquid crystal display panel through a lead to be supplied with a second voltage signal.

For example, in the liquid crystal display panel provided by an embodiment of the present disclosure, in a plane parallel to the second base substrate, the conductive structure is located on a side of the second common electrode line away from the display region and on a side of the second common electrode line close to an input port of the liquid crystal display panel.

For example, in the liquid crystal display panel provided by an embodiment of the present disclosure, a difference between the first voltage signal and the second voltage signal is in a range from 0 to 3 V.

For example, in the liquid crystal display panel provided by an embodiment of the present disclosure, the plurality of pixel structures are arranged along a first direction and a second direction, and the second direction intersects with the first direction, in each of the plurality of pixel structures, the common electrode includes a plurality of first slots extending along the first direction and arranged along the second direction, the electrostatic discharge layer includes a plurality of electrostatic discharge portions corresponding to the plurality of pixel structures, and each of the plurality of electrostatic discharge portions includes a plurality of second slots extending along the first direction and arranged along the second direction.

For example, in the liquid crystal display panel provided by an embodiment of the present disclosure, in each of the plurality of pixel structures, the plurality of second slots are arranged at equal intervals, in the second direction, a ratio of a dimension between two adjacent ones of the plurality of second slots to a dimension of each of the plurality of the second slots is in a range from 1.0 to 1.5.

For example, in the liquid crystal display panel provided by an embodiment of the present disclosure, in each of the plurality of pixel structures, the plurality of first slots and the plurality of second slots are arranged in one-to-one correspondence, in the second direction, dimensions of one of the plurality of first slots and one of the plurality of second slots that are arranged in correspondence with each other are the same.

For example, in the liquid crystal display panel provided by an embodiment of the present disclosure, in each of the plurality of pixel structures, the array substrate further includes a block-shaped pixel electrode, and the block-shaped pixel electrode is located between the second base substrate and the common electrode layer.

For example, in the liquid crystal display panel provided by an embodiment of the present disclosure, the opposite substrate further includes: a black matrix layer, disposed on a side of the second base substrate facing the array substrate; a color film layer, disposed on a side of the second base substrate facing the array substrate; and a planarization layer, disposed on a side of both the black matrix layer and the color film layer facing the array substrate, wherein the anti-overflow structure is disposed on a side of the planarization layer facing the array substrate.

At least one embodiment of the present disclosure provides a display device, including any one of the above-mentioned liquid crystal display panels.

### BRIEF DESCRIPTION OF DRAWINGS

In order to clearly illustrate the technical solution of the embodiments of the present disclosure, the drawings of the embodiments will be briefly described. It is obvious that the described drawings in the following are only related to some embodiments of the present disclosure and thus are not limitative of the present disclosure.

FIG. 1 is a schematic diagram illustrating diffusion of 0.2 mg liquid crystal droplet.

FIG. 2 is a schematic cross-sectional view of a liquid crystal display panel according to an embodiment of the present disclosure.

FIG. 3 is a schematic diagram of an anti-overflow structure of an opposite substrate provided by an embodiment of the present disclosure.

FIG. 4 is a schematic diagram of an anti-overflow structure of another opposite substrate provided by an embodiment of the present disclosure.

FIG. 5 is a schematic diagram of an anti-overflow structure of another opposite substrate provided by an embodiment of the present disclosure.

FIG. 6 is a schematic sectional view of a liquid crystal display panel illustrated by FIG. 5.

FIG. 7 is a schematic diagram of an anti-overflow cofferdam of another opposite substrate provided by an embodiment of the present disclosure.

FIG. 8 is a schematic diagram of an anti-overflow structure of another opposite substrate provided by an embodiment of the present disclosure.

FIG. 9 is a schematic diagram of an anti-overflow structure of another opposite substrate provided by an embodiment of the present disclosure.

FIG. 10 is a schematic diagram of an anti-overflow structure of another opposite substrate provided by an embodiment of the present disclosure.

FIG. 11A is a schematic diagram of another anti-overflow cofferdam provided by an embodiment of the present disclosure.

FIG. 11B is a partial schematic diagram of an anti-overflow cofferdam illustrated by FIG. 11A.

FIG. 12 is a schematic diagram of another anti-overflow cofferdam provided by an embodiment of the present disclosure.

FIG. 13 is a schematic diagram of an anti-overflow structure of another opposite substrate provided by an embodiment of the present disclosure.

FIG. 14 is a schematic diagram of an anti-overflow structure of another opposite substrate provided by an embodiment of the present disclosure.

FIG. 15 is a schematic diagram of static electricity in an opposite substrate of a liquid crystal display panel.

FIG. 16 is a schematic sectional view of a liquid crystal display panel according to an embodiment of the present disclosure.

FIG. 17 is a schematic partial structural diagram of a liquid crystal display panel of FIG. 16.

FIG. 18 is a partial enlarged view of FIG. 17 at positions A and B.

FIG. 19 is a partial enlarged view of FIG. 17 at positions C and D.

FIG. 20 is a partial enlarged view of FIG. 17.

FIG. 21 is a schematic cross-sectional view of conductive layers of FIG. 17.

FIG. 22 is a partial enlarged view of FIG. 17 at position E.

FIG. 23 is a schematic cross-sectional view of FIG. 22.

FIG. 24 is a schematic electric field diagram of a liquid crystal display panel.

FIG. 25 is a schematic partial structural diagram of another liquid crystal display panel of FIG. 16.

FIG. 26 is a schematic partially enlarged schematic view of FIG. 25.

FIG. 27 is a partial enlarged view of FIG. 25 at positions F and G.

FIG. 28 is a partial enlarged view of FIG. 25 at position J.

FIG. 29 is a partial enlarged view of FIG. 25 at position K.

FIG. 30 is a schematic cross-sectional view of FIG. 28.

FIG. 31 is a schematic partial cross-sectional view of another liquid crystal display panel provided by an embodiment of the present disclosure.

FIG. 32 is a schematic partial top view of a corresponding pixel structure in FIG. 31.

FIG. 33 is a schematic partial cross-sectional view of another liquid crystal display panel 100 according to an embodiment of the present disclosure.

FIG. 34 is a schematic partial top view of a corresponding pixel structure in FIG. 33.

FIG. 35 is a schematic partial cross-sectional view of another liquid crystal display panel provided by an embodiment of the present disclosure.

FIG. 36 is a schematic partial top view of a corresponding pixel structure in FIG. 35.

FIG. 37 is a light effect diagram at L255 grayscale of two solutions according to the embodiment of the present disclosure.

FIG. 38 is a schematic diagram of liquid crystal deflection simulation of a liquid crystal display panel illustrated by FIG. 31 at LO grayscale.

FIG. 39 is a light effect diagram of a liquid crystal display panel illustrated by FIG. 35 at L255 grayscale.

FIG. 40 is a schematic diagram of liquid crystal deflection simulation of a liquid crystal display panel illustrated by FIG. 35 at L255 grayscale.

FIG. 41 is a schematic diagram of a display device provided by an embodiment of the present disclosure.

FIG. 42 is a flowchart of a method for manufacturing a liquid crystal display panel according to an embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., used in the present disclosure are not intended to indicate any sequence, amount or importance, but distinguish different components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not limited to a physical connection or mechanical connection, but may also include an electrical connection, directly or indirectly.

Unless otherwise defined, the features of “parallel”, “vertical” and “identical” used in the embodiments of the present disclosure include the strict sense of “parallel”, “vertical” and “identical”, as well as the situations involving certain errors such as “substantially parallel”, “substantially vertical” and “substantially identical”. For example, the above-mentioned “substantially” can indicate that the difference value of the compared object is within 10% or 5% of the average value of the compared object. When the number of a component or element is not specifically indicated in the following embodiments of the present disclosure, it means that the component or element can be one or more, or can be understood as at least one. “At least one” refers to one or more, and “more than one” refers to at least two. The “arranged in the same layer” in the embodiments of the present disclosure refers to the relationship between multiple film layers formed by the same material after the same step (e.g., a one-step patterning process). Here, “in the same layer” does not always refer to the thickness of multiple film layers being the same or the height of multiple film layers being the same in the cross-sectional view.

At present, there are few miniaturized thin film transistor (TFT) liquid crystal displays with a size of 1 inch or less on the market, and the market of the thin film transistor liquid crystal display with a size of 0.4 to 0.8 inch is in a blank stage, and there is no product channel at present.

There are many problems to be overcome in the production process of the miniaturized liquid crystal display. In the one drop filling (ODF) stage of the liquid crystal, because the liquid crystal content of the product is too small, the liquid crystal dripping equipment cannot drip accurately, and the liquid tension can also limit the dripping speed. A large number of tests are needed to verify the position accuracy of liquid crystal droplet drip, an upper limit of a number of cuts that can be stably dripped, the accuracy of drip dosage and the time taken for drip.

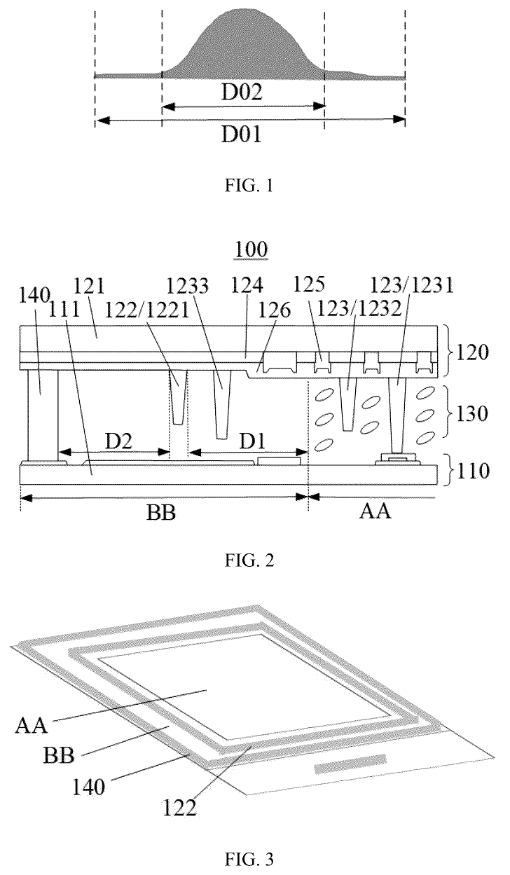

Usually, the process of one drop filling stage of the liquid crystal of the miniaturized thin film transistor liquid crystal display is that the liquid crystal is dripped on the array substrate, the frame sealing adhesive is coated on the opposite substrate, then cell-assembling is performed in vacuum environment, and finally the atmospheric pressure is released and entering the cutting process. Taking the development of a product with a size of 0.42 inch as an example, FIG. 1 is a schematic diagram illustrating diffusion of 0.2 mg liquid crystal droplet. As illustrated by FIG. 1, a diffusion diameter D01 of liquid crystal droplet (about 0.2 mg) on an array substrate of this product before cell-assembling is about 9 mm, which has exceeded a minimum inner spacing D02 (about 6.4 mm) of a sealing frame in the liquid crystal cell.

In the one drop filling stage of the liquid crystal, for example, the liquid crystal droplet is 0.2 mg/dot, a piece of glass with a size of 1300 mm*1100 mm needs more than 10,000 cuts. If the liquid crystal is completely dripped, the first dripped droplet has diffused beyond a boundary of the sealing frame of the panel, then the cell-assembling cannot be normally conducted. In addition, the smaller the size of the TFT liquid crystal display, the greater the impact of liquid crystal droplet on the frame sealing adhesive when the array substrate and the opposite substrate are cell-assembled, which will lead to the puncture problem and may even lead to the risk of penetration and fracture of the frame sealing adhesive.

In this regard, Embodiments of the present disclosure provide a liquid crystal display panel and a display device. The liquid crystal display panel includes an array substrate and an opposite substrate which are oppositely arranged, and a liquid crystal layer disposed between the array substrate and the opposite substrate, the array substrate includes a first base substrate and a plurality of pixel structures located on the first base substrate; the opposite substrate includes a second base substrate and an anti-overflow structure which is disposed on a side of the second base substrate facing the array substrate and is configured to prevent liquid crystal in the liquid crystal layer from overflowing. The liquid crystal display panel includes a display region and a peripheral region surrounding the display region, and further includes a frame sealing adhesive located in the peripheral region and disposed between the array substrate and the opposite substrate, and the anti-overflow structure surrounds the display region and is disposed on a side of the frame sealing adhesive close to the display region.

In the liquid crystal display panel provided by the embodiment of the present disclosure, the anti-overflow structure is disposed on the opposite substrate, and the anti-overflow structure is disposed on the side of the frame sealing adhesive close to the display region, after a liquid crystal droplet is dripped on the opposite substrate, the anti-overflow structure can prevent liquid crystal from overflowing, prevent the liquid crystal from diffusing to the boundary of the frame sealing adhesive, and prevent the diffusion of the liquid crystal from affecting the cell-assembling of the array substrate and the opposite substrate. In addition, the anti-overflow structure can further buffer the impact of the liquid crystal droplet on the frame sealing adhesive, solve the puncture problem and improve the yield of products.

Hereinafter, the liquid crystal display panel and the display device provided by the embodiments of the present disclosure will be described in detail with reference to the accompanying drawings.

An embodiment of the present disclosure provides a liquid crystal display panel. FIG. 2 is a schematic cross-sectional view of a liquid crystal display panel according to an embodiment of the present disclosure. As illustrated by FIG. 2, a liquid crystal display panel 100 includes an array substrate 110 and an opposite substrate 120 that are oppositely disposed, and a liquid crystal layer 130 disposed between the array substrate 110 and the opposite substrate 120. The array substrate 110 includes a first base substrate 111 and a plurality of pixel structures located on the first base substrate 111, and the opposite substrate 120 includes a second base substrate 121 and an anti-overflow structure 122, the anti-overflow structure 122 is disposed on a side of the second base substrate 121 facing the array substrate 110, and configured to present the liquid crystal in the liquid crystal layer 130 from overflowing. The liquid crystal display panel 100 includes a display region AA and a peripheral region BB surrounding the display region AA. The liquid crystal display panel 100 further includes a frame sealing adhesive 140 located in the peripheral region BB and disposed between the array substrate 110 and the opposite substrate 120. The anti-overflow structure 122 surrounds the display region AA and is disposed on a side of the frame sealing adhesive 140 close to the display region AA.

In the liquid crystal display panel 100 provided by the embodiment of the present disclosure, the anti-overflow structure 122 is disposed on the opposite substrate 120, and the anti-overflow structure 122 is disposed on the side of the frame sealing adhesive 140 close to the display region AA, after a liquid crystal droplet is dripped on the opposite substrate 120, the anti-overflow structure 122 can prevent liquid crystal from overflowing, prevent the liquid crystal from diffusing to a boundary of the frame sealing adhesive 140, and prevent the diffusion of the liquid crystal from affecting the cell-assembling of the array substrate 110 and the opposite substrate 120. In addition, the anti-overflow structure 122 can further buffer the impact of the liquid crystal droplet on the frame sealing adhesive 140, solve the puncture problem and improve the yield of products. It should be noted that the anti-overflow structure 122 is used to prevent the liquid crystal from overflowing in the one drop filling (ODF) stage, so that the array substrate 110 and the opposite substrate 120 can be cell-assembled normally.

In the present disclosure, the pixel structure of the array substrate 110 includes a pixel driving circuit and a pixel electrode. For example, the pixel driving circuit may be connected with the pixel electrode to load a pixel driving signal, thereby controlling a deflection of the liquid crystal. For example, a plurality of pixel structures correspond to a plurality of sub-pixels for realizing luminous display of different colors. In some examples, the pixel structure further includes a common electrode for generating an electric field with the pixel electrode.

In some examples, a maximum dimension of the display region AA of the liquid crystal display panel 100 in a plane parallel to the second base substrate 121 is less than or equal to 30 mm. The smaller an area of the display region AA of the liquid crystal display panel 100 is, limited by a size of the entire liquid crystal display panel 100, the smaller a distance between the liquid crystal and the frame sealing adhesive 140 will be, and the easier it is for the liquid crystal to overflow to the frame sealing adhesive 140; moreover, the smaller the area of the display region AA is, the smaller a number of the liquid crystal droplets will be, for example, the number of the liquid crystal droplet(s) may be only one or two, if waiting for the one drop filling stage of the liquid crystal to be completely completed, the first dripped droplet may have diffused to a position of the frame sealing adhesive 140. Therefore, for the liquid crystal display panel 100 with a small dimension, the anti-overflow structure 122 is more needed to prevent the liquid crystal from overflowing and diffusing to the boundary of the frame sealing adhesive 140. In addition, the smaller the size of the liquid crystal display panel 100 is, the greater the impact of the liquid crystal droplet on the frame sealing adhesive 140 will be, and it is more needed to dispose the anti-overflow structure 122 to reduce the impact of the liquid crystal droplet on the frame sealing adhesive 140 and solve the puncture problem.

For example, the display region AA of the liquid crystal display panel 100 may be in a shape of a rectangle, and a length of a diagonal of the rectangle is less than or equal to 30 mm. For example, the display region AA of the liquid crystal display panel 100 may be a circle, and a diameter of the circle is less than or equal to 30 mm.

In some examples, as illustrated by FIG. 2, in the plane parallel to the second base substrate 121, a distance D1 between the anti-overflow structure 122 and the display region AA is in a range from 100 μm to 300 μm, therefore, it can avoid the accumulation of the alignment layer on the anti-overflow structure 122 caused by an overly short distance between the anti-overflow structure 122 and the display region AA, prevent the anti-overflow structure 122 from affecting the alignment layer, and avoid the uneven display caused thereby.

In some examples, as illustrated by FIG. 2, in the plane parallel to the second base substrate 121, a distance D2 between the anti-overflow structure 122 and the frame sealing adhesive 140 is in a range from 100 μm to 300 μm. Therefore, it can prevent the frame sealing adhesive 140 from accumulating on the anti-overflow structure 122 due to an overly short distance between the anti-overflow structure 122 and the frame sealing adhesive 140 caused by the fluctuation of the coating accuracy of the frame sealing adhesive 140, thereby preventing a thickness of the peripheral region BB of the liquid crystal display panel 100 from increasing, and avoiding the problems of display yellowing and the like.

In some examples, as illustrated by FIG. 2, the opposite substrate 120 further includes a spacer 123, which is located in the display region AA and disposed on a side of the second base substrate 121 facing the array substrate 110, and the anti-overflow structure 122 is configured to be formed by a same material and a same patterning process as the spacer 123. The anti-overflow structure 122 and the spacer 123 are formed by the same material through the same patterning process, so that the formation of the anti-overflow structure 122 does not require additional process steps and production costs. For example, as illustrated by the figure, the anti-overflow structure 122 and the spacer 123 formed by the same material through the same patterning process have a same cross section.

In some examples, as illustrated by FIG. 2, the spacer 123 includes a main spacer 1231 and an auxiliary spacer 1232, and a height of the main spacer 1231 is greater than a height of the auxiliary spacer 1232 in the direction perpendicular to the second base substrate 121. In the case that the anti-overflow structure 122 and the spacer 123 are formed by the same material and the same patterning process, a height of the anti-overflow structure 122 may be the same as the height of the main spacer 1231, or may be the same as the height of the auxiliary spacer 1232.

In some examples, as illustrated by FIG. 2, the anti-overflow structure 122 includes an anti-overflow cofferdam 1221, and the anti-overflow structure 122 is disposed as a cofferdam to prevent the overflow of the liquid crystal more effectively. Of course, the embodiment of present disclosure does not limit a height of the anti-overflow cofferdam 1221 in the direction perpendicular to the second base substrate 121, which can be designed according to the size of the product and process requirements.

In some examples, in the case that a total volume of the liquid crystal in the liquid crystal layer 130 accounts for a large proportion of a volume component of the display region, for example, in the case that an inner spacing of the frame sealing adhesive 140 is less than 6 mm, the height of the anti-overflow cofferdam 1221 can be set relatively high in the direction perpendicular to the second base substrate 121, and the high anti-overflow cofferdam 1221 can ensure that the liquid crystal does not overflow and has stronger puncture resistance. For example, the height of the anti-overflow cofferdam 1221 may be the same as the height of the main spacer. In the case that the total volume of the liquid crystal volume of the liquid crystal layer 130 accounts for a moderate proportion of the volume component of the display region, for example, in the case that the inner spacing of the frame sealing adhesive 140 is greater than 6 mm, the height of the anti-overflow cofferdam 1221 can be moderate in the direction perpendicular to the second base substrate 121, for example, the height of the anti-overflow cofferdam 1221 may be the same as the height of the auxiliary spacer 1232, therefore, the possibility that the gap in the peripheral region BB becomes high caused by the accumulation of the frame sealing adhesive 140 on the anti-overflow structure 122 can be reduced to the greatest extent, and the problems of display yellowing and the like can be avoided. The volume component of the display region refers to a product of the area of the display region AA and the thickness of the cell after the array substrate 110 and the opposite substrate 120 are cell-assembled.

In addition, the height of the anti-overflow cofferdam 1221 is moderate or the same as the height of the auxiliary spacer 1232, which can further make the liquid crystal droplet have better fluidity after dripping on the opposite substrate 120, so that the liquid crystal can be more evenly filled in the display region AA, and a vacuum bubble can be avoided after the array substrate 110 and the opposite substrate 120 are cell-assembled.

FIG. 3 is a schematic diagram of an anti-overflow structure of an opposite substrate provided by an embodiment of the present disclosure. As illustrated by FIG. 3, the anti-overflow structure 122 includes a closed structure surrounding the display region AA, so that the anti-overflow structure 122 can effectively block the overflow of the liquid crystal. In this example, the display region AA of the liquid crystal display panel 100 may be rectangular.

In some examples, as illustrated by FIG. 3, the liquid crystal display panel 100 is rectangular, the inner spacings of the frame sealing adhesive 140 of the liquid crystal display panel 100 is respectively 6.4 mm and 10.2 mm, and the liquid crystal droplet of the liquid crystal display panel 100 dripping to the opposite substrate 120 is 0.2 mg. Therefore, the anti-overflow structure 122 in any of the above embodiments can effectively prevent the overflow of liquid crystal and the impact on the frame sealing adhesive 140.

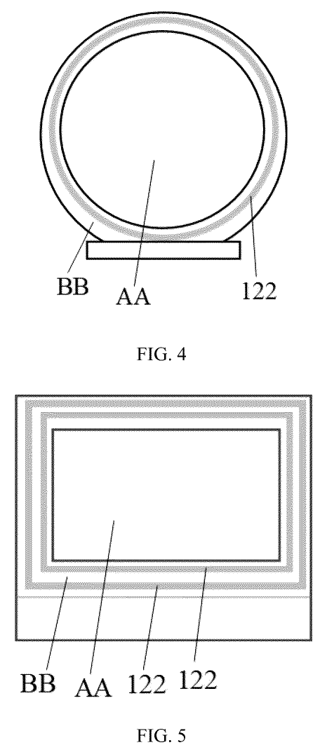

FIG. 4 is a schematic diagram of an anti-overflow structure of another opposite substrate provided by an embodiment of the present disclosure. As illustrated by FIG. 4, the anti-overflow structure 122 includes a closed structure surrounding the display region AA, so that the anti-overflow structure 122 can effectively block the overflow of the liquid crystal. In this example, the display region AA of the liquid crystal display panel 100 is circular. Of course, the embodiment of the present disclosure does not limit the shape of the display region AA of the liquid crystal display panel 100. For example, the display region AA may also be oval, polygonal or irregular, and the shape of the anti-overflow structure 122 can follow the shape of the display region AA.

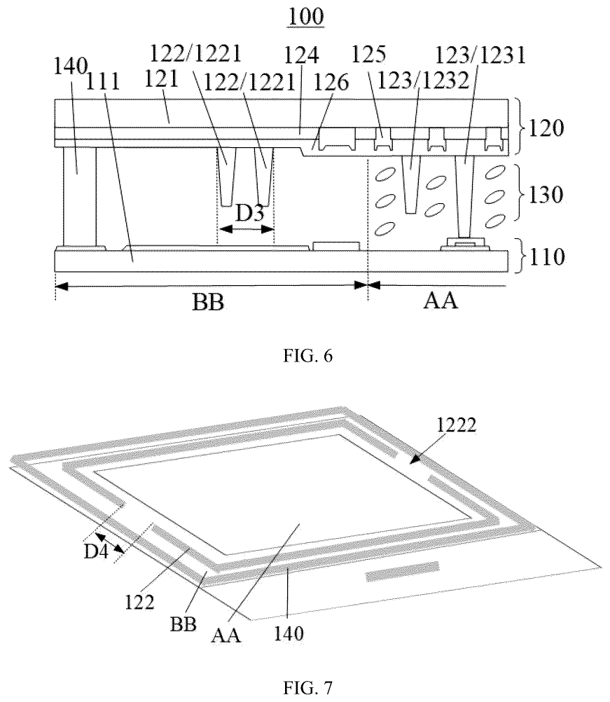

FIG. 5 is a schematic diagram illustrating an anti-overflow structure of another opposite substrate provided by an embodiment of the present disclosure; FIG. 6 is a schematic sectional view of a liquid crystal display panel illustrated by FIG. 5. As illustrated by FIGS. 5 and 6, the liquid crystal display panel 100 includes two rings of anti-overflow structures 122, and the two rings of anti-overflow structures 122 are closed structures. Of course, the embodiment of the present disclosure does not limit a number of the anti-overflow structure(s) 122.

In some examples, as illustrated by FIGS. 5 and 6, in the direction perpendicular to the second base substrate 121, the dimensions of a plurality rings of anti-overflow structures 122 may be the same. Of course, in the direction perpendicular to the second base substrate 121, the dimensions of the plurality rings of anti-overflow structures 122 may also be different.

In some examples, as illustrated by FIG. 6, widths D3 of the plurality of anti-overflow structure 122 are in a range from 50 μm to 150 μm.

FIG. 7 is a schematic diagram of an anti-overflow cofferdam of another opposite substrate provided by an embodiment of the present disclosure. As illustrated by FIG. 7, the display region AA of the liquid crystal display panel 100 is rectangular, and the anti-overflow cofferdam 1221 is substantially rectangular around the display region AA in the plane parallel to the second base substrate 121. The display region AA includes two long edges which are opposite to each other and two short edges which are opposite to each other. The anti-overflow cofferdam 1221 includes two notches 1222, and the two notches 1222 of the anti-overflow structure 122 are respectively disposed at sides where the short edges of the display region AA are located. The notches 1222 at the short edge sides of the anti-overflow structure 122 are relatively far away from a center of the display region AA, arranging the notches 1222 at the short edge sides can not only effectively prevent the liquid crystal from overflowing, but also improve the fluidity of the liquid crystal flowing toward the short edges far away from the center of the display region AA, so that the liquid crystal can be filled in the display region AA more evenly, and vacuum bubble can be avoided after the array substrate 110 and the opposite substrate 120 are cell-assembled.

For example, as illustrated by FIG. 7, the two notches 1222 of the anti-overflow structure 122 may be respectively disposed at centers of the short edge sides of the display region AA. When the array substrate 110 and the opposite substrate 120 are cell-assembled, the liquid crystal is squeezed and diffused to the periphery, compared with arranging the notches 1222 at edge positions of the short edge sides, arranging the notches 1222 at the centers of the short edge sides is more conducive to the uniform diffusion of the liquid crystal, so as to avoid the vacuum bubble after cell-assembling.

For example, the notch 1222 illustrated by FIG. 7 penetrates through the anti-overflow cofferdam 1221 in the direction perpendicular to the second base substrate 121, however, the notch 1222 may not penetrate through the anti-overflow cofferdam 1221 in the direction perpendicular to the second base substrate 121.

For example, as illustrated by FIG. 7, the position where liquid crystal droplet drips on the opposite substrate 120 is at the center of the display region AA, and a distance between the position and the short edge is greater than a distance between the position and the long edge, by arranging the notches 1222 at the centers of the sides where the short edges are located, the overflow of liquid crystal can be effectively prevented, and the fluidity of liquid crystal droplet diffusing towards the short edge can be improved. Of course, the embodiment of disclosure does not limit the position and number of the notches 1222, and can be verified according to a size of the actual product and the number and position of the droplets to determine the optimal position and number of the notches 1222.

For example, there are a plurality of positions where the liquid crystal droplets drip to the opposite substrate 120, and at least one of the positions is not at the center of the display region AA, and the distance between the position and the long edge is greater than the distance between the position and the short edge, in this case, the notch 1222 may be disposed at a side where the long edge of the display region AA is located. For example, a plurality of notches 1222 may be provided at the sides where the long edges are located to increase the fluidity of liquid crystal droplet.

The embodiment of the present disclosure does not limit the number, shape and position of the notches 1222 of the anti-overflow cofferdam 1221. For example, the anti-overflow cofferdam 1221 may include a plurality of notches 1222, and the shape of the anti-overflow cofferdam 1221 at the plane parallel to the second base substrate 12 includes a polygon, and the notches 1222 are disposed at centers of a plurality of edges of the anti-overflow cofferdam 1221. For example, the number of the notches 1222 of the anti-overflow cofferdam 1221 is half of the number of the edges of the anti-overflow cofferdam 1221. For example, the plurality of notches 1222 are oppositely arranged.

In some examples, as illustrated by FIG. 7, a dimension D4 of the notch 1222 in an extension direction of the anti-overflow cofferdam 1221 may account for 15% to 25% of a length of the edge where the notch 1222 is located. Of course, the embodiment of the present disclosure is not limited thereto, and can be tested and verified according to the actual product to obtain the optimal value.

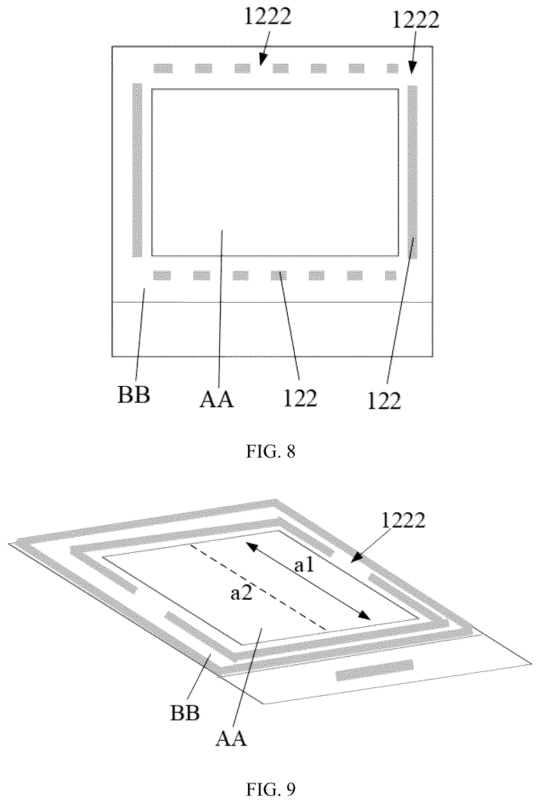

FIG. 8 is a schematic diagram of an anti-overflow structure of another opposite substrate provided by an embodiment of the present disclosure. As illustrated by FIG. 8, the anti-overflow cofferdam 1221 includes a plurality of notches 1222, the plurality of notches 1222 are respectively disposed at sides where the long edges of the display region AA are located, also disposed at four corners of the display region AA, so that the fluidity of the liquid crystal droplet can be better improved.

FIG. 9 is a schematic diagram of an anti-overflow structure of another opposite substrate provided by an embodiment of the present disclosure. As illustrated by FIG. 9, the opposite substrate 120 further includes an alignment layer, which is disposed on a side of the second base substrate 121 facing the array substrate 110 and includes an alignment direction a1. The display region AA has a center line a2 passing through the center of the display region AA and along the alignment direction a1, the notch 1222 is located at a position, farthest from the center line a2, of the anti-overflow cofferdam 1221. In the figure, the anti-overflow cofferdam 1221 is rectangular in shape, and the notch 1222 is located at the center of the edge of the anti-overflow cofferdam 1221 farthest from the center line a2. For example, in the case that the anti-overflow cofferdam 1221 is circular in shape, the notch 1222 is located at the position, farthest from the center line a2, of the anti-overflow cofferdam 1221. In this example, the fluidity of the liquid crystal is related to the alignment direction al of the alignment layer, and the fluidity of the liquid crystal along the alignment direction a1 is better than the fluidity of the liquid crystal along a direction perpendicular to the alignment direction a1. Setting the notch 1222 at the position farthest from the center line a2 along the alignment direction al can improve the fluidity of the liquid crystal along the direction perpendicular to the alignment direction a1.

The embodiment of the present disclosure does not limit a position of the alignment layer, and the alignment layer may be located at a side of the spacer 123 facing the array substrate 110 or between the spacer 123 and the second base substrate 121.

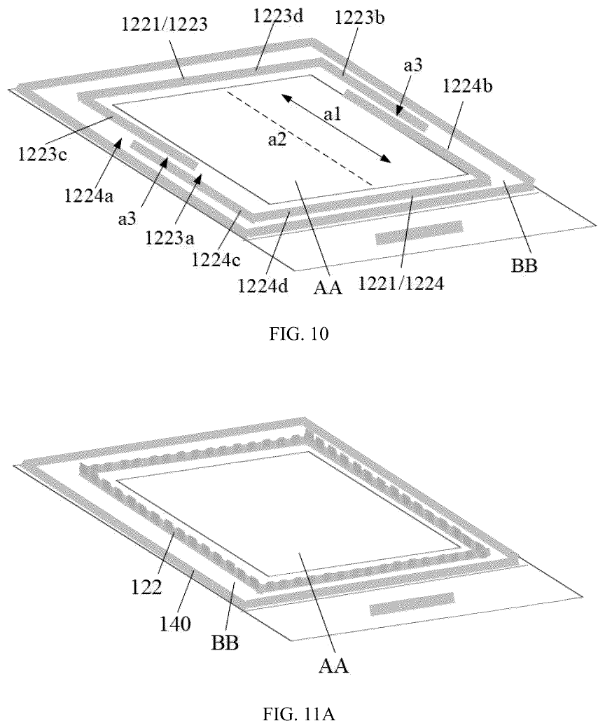

FIG. 10 is a schematic diagram of an anti-overflow structure of another opposite substrate provided by an embodiment of the present disclosure. As illustrated by FIG. 10, the anti-overflow cofferdam 1221 includes a first anti-overflow cofferdam 1223 and a second anti-overflow cofferdam 1224, the first anti-overflow cofferdam 1223 includes a first opening 1223a and the second anti-overflow cofferdam 1224a includes a second opening 1224a. The first opening 1223a and the second opening 1224a are opposite to each other, and the first anti-overflow cofferdam 1223 and the second anti-overflow cofferdam 1224 have a overlapping region. In the overlapping region, the first anti-overflow cofferdam 1223 and the second anti-overflow cofferdam 1224 are arranged at intervals to form a channel a3. In the case that the liquid crystal display panel 100 is relatively small, for example, in the case that the inner spacings of the frame sealing adhesive 140 are each less than 9 mm, referring to FIG. 1, the diffusion range of the liquid crystal droplet is larger than the inner spacing of the frame sealing adhesive 140. In this case, even if the notch 1222 of the anti-overflow cofferdam 1221 is arranged at the position farthest from the center, there is also a risk of overflow. By arranging the first anti-overflow cofferdam 1223 and the second anti-overflow cofferdam 1224 to have the overlapping region and be arranged at intervals to form the channel a3, the fluidity of the liquid crystal can be improved through the channel a3, and the overflow of the liquid crystal can be avoided through the overlapping region, so as to avoid the diffusion problem of the liquid crystal as much as possible.

In some examples, as illustrated by FIG. 10, the display region AA includes the center line a2 passing through the center of the display region AA along the alignment direction al, and the overlapping region is disposed at a position, farthest from the center line a2, of the anti-overflow cofferdam 1221. In the figure, the anti-overflow cofferdam 1221 is substantially rectangular in shape, and the overlapping region is located at the center position of the edge of the anti-overflow cofferdam 1221 farthest from the center line a2. For example, in the case that the anti-overflow cofferdam 1221 is circular in shape, the overlapping region is located at the position, farthest from the center line a2, of the anti-overflow cofferdam 1221. In this example, the fluidity of the liquid crystal is related to the alignment direction al of the alignment layer, and the fluidity of the liquid crystal along the alignment direction a1 is better than the fluidity of the liquid crystal along a direction perpendicular to the alignment direction a1. Setting the overlapping region at the farthest position from the center line a2 along the alignment direction a1 can improve the fluidity of the liquid crystal along the direction perpendicular to the alignment direction a1.

In some examples, as illustrated by FIG. 10, the first anti-overflow cofferdam 1223 includes a first sub-portion 1223b and a second sub-portion 1223c which are opposite to each other, and a first connection portion 1223d which connects the first sub-portion 1223b and the second sub-portion 1223c, and the second anti-overflow cofferdam 1224 includes a third sub-portion 1224b and a fourth sub-portion 1224c which are opposite to each other, and a second connection portion 1224d which connects the third sub-portion 1224b and the fourth sub-portion 1224c. The first sub-portion 1223b and the third sub-portion 1224b have the overlapping region and are arranged at intervals to form the channel a3, and the second sub-portion 1223c and the fourth sub-portion 1224c have the overlapping region and are arranged at intervals to form the channel a3.

FIG. 11A is a schematic diagram of another anti-overflow cofferdam provided by an embodiment of the present disclosure; FIG. 11B is a partial schematic diagram of an anti-overflow cofferdam illustrated by FIG. 11A. As illustrated by FIGS. 11A and 11B, the anti-overflow cofferdam 1221 includes a plurality of first anti-overflow portions 1225 and a plurality of second anti-overflow portions 1226, and a dimension of the first anti-overflow portion 1225 is larger than a dimension of the second anti-overflow portion 1226 in the direction perpendicular to the second base substrate 121. In the extending direction a4 of the anti-overflow cofferdam 1221, the first anti-overflow portions 1225 and the second anti-overflow portions 1226 are alternately arranged. By alternately arranging the first anti-overflow portions 1225 and the second anti-overflow portions 1226, the overflow of the liquid crystal can be avoided and the fluidity of the liquid crystal can be improved. The embodiment of the present disclosure does not limit the numbers, heights, and lengths, along the extending direction a4 of the anti-overflow cofferdam 1221, of the first anti-overflow portion 1225 and the second anti-overflow portion 1226, which can be designed and matched according to the size of the liquid crystal display panel 100 and the alignment direction al of the alignment layer.

For example, the height of the first anti-overflow portion 1225 may be the same as the height of the main spacer 1231, and the height of the second anti-overflow portion 1226 may be the same as the height of the auxiliary spacer 1232.

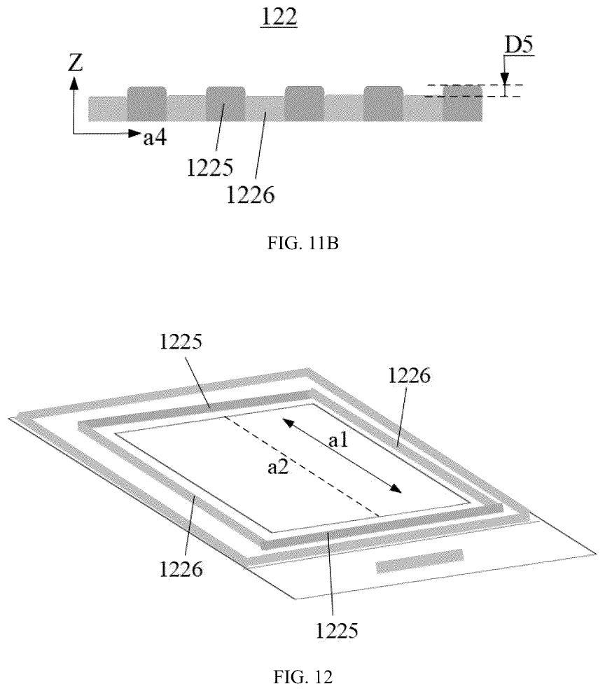

In some examples, as illustrated by FIG. 12, a difference D5 between the height of the first anti-overflow portion 1225 and the height of the second anti-overflow portion 1226 is in a range from 0.5 μm to 0.65 μm in the direction Z perpendicular to the second base substrate 121.

In some examples, along the extending direction a4 of the anti-overflow cofferdam 1221, the length of the first anti-overflow portion 1225 is greater than 15 μm, and the length of the second anti-overflow portion 1226 is greater than 15 μm, so that the first anti-overflow portion 1225 and the second anti-overflow portion 1226 which are alternately arranged can have more obvious dimension characteristics, which can better avoid the overflow of the liquid crystal and improve the fluidity of the liquid crystal.

FIG. 12 is a schematic diagram of another anti-overflow cofferdam provided by an embodiment of the present disclosure. As illustrated by FIG. 12, a set of opposite edges of the anti-overflow cofferdam 1221 are the first anti-overflow portions 1225, and another set of opposite edges of the anti-overflow cofferdam 1221 are the second anti-overflow portions 1226, the two adjacent edges of the anti-overflow cofferdam 1221 are the first anti-overflow portion 1225 and the second anti-overflow portion 1226 respectively. Multiple edges of the anti-overflow cofferdam 1221 can be set to have different heights in combination with the size of the liquid crystal display panel 100, the position of liquid crystal droplet, the alignment direction a1 of the alignment layer, etc., which can not only prevent the liquid crystal from overflowing, but also improve the fluidity of the liquid crystal.

For example, as illustrated by FIG. 12, edges of the anti-overflow cofferdam 1221 perpendicular to the alignment direction al is the first anti-overflow portions 1225, and edges of the anti-overflow cofferdam 1221 parallel to the alignment direction al is the second anti-overflow portions 1226, which can ensure the fluidity of the liquid crystal and avoid the overflow of the liquid crystal. For example, the height of the edge of the anti-overflow cofferdam 1221 perpendicular to the alignment direction al may be the same as the height of the main spacer 1231, and the height of the edge of the anti-overflow cofferdam 1221 parallel to the alignment direction al may be the same as the height of the auxiliary spacer 1232.

In some examples, as illustrated by FIG. 2, the opposite substrate 120 further includes a black matrix layer 124, a color film layer 125 and a planarization layer 126, the black matrix layer 124 is disposed on a side of the second base substrate 121 facing the array substrate 110, and the color film layer 125 is disposed on a side of the second base substrate 121 facing the array substrate 110, and the planarization layer 126 is disposed on a side of both the black matrix layer 124 and the color film layer 125 facing the array substrate 110. The spacers 123 and the anti-overflow cofferdam 1221 are disposed on a side of the planarization layer 126 close to the array substrate 110.

In some examples, as illustrated by FIG. 2, the opposite substrate 120 may further include a peripheral spacer 1233 located in the peripheral region BB and surrounding the display region AA. The peripheral spacer 1233 is a columnar structure, and the peripheral spacer 1233 is disposed on a side of the planarization layer 126 facing the array substrate 110. For example, the peripheral spacer 1233 is configured to be formed by a same material and a same patterning process as the spacer 123. Therefore, the formation of the peripheral spacer 1233 does not require additional process steps and production costs. For example, in the direction perpendicular to the second base substrate 121, a height of the peripheral spacer 1233 may be the same as the height of the main spacer 1231.

In some examples, as illustrated by FIG. 2, the color film layer 125 is located on a side of the anti-overflow structure 122 close to the display region AA. For example, the color film layer 125 is further located on a side of the peripheral spacer 1233 close to the display region AA. Therefore, the increase in the thickness of the peripheral region BB caused by the superimposition of the color film layers 125 can be avoided, and the problems of display yellowing and the like can be avoided.

In some examples, a material of the planarization layer 126 may be photoresist. Of course, the embodiment of the present disclosure does not limit the material of the planarization layer 126. For example, the planarization layer 126 may also be other functional layers on the opposite substrate 120.

In some examples, as illustrated by FIG. 2, the opposite substrate 120 may include the black matrix layer 124, the color film layer 125 and the planarization layer 126 sequentially formed on the second base substrate 121, and then the spacers 123 and the anti-overflow cofferdam 1221 are formed by the same material through the same patterning process. For example, the conductive layer may be further formed on a side of the second base substrate 121 away from the array substrate 110, and is used to release static electricity at the side of the opposite substrate 120 away from the array substrate 110.

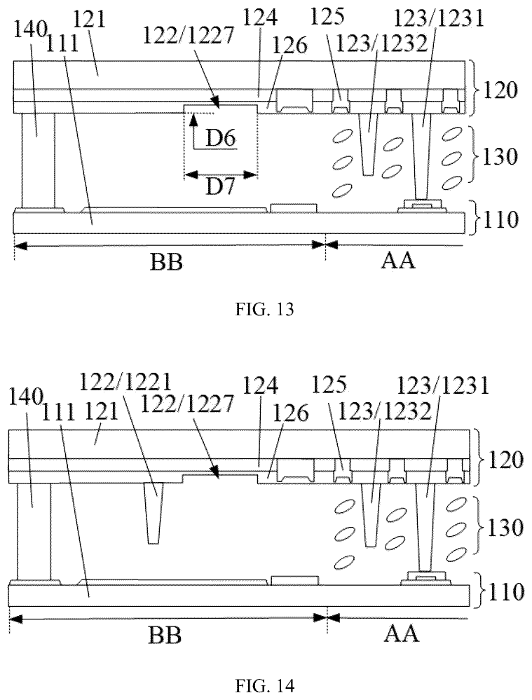

FIG. 13 is a schematic diagram of an anti-overflow structure of another opposite substrate provided by an embodiment of the present disclosure. As illustrated by FIG. 13, the opposite substrate 120 further includes a planarization layer 126, which is disposed on a side of the second base substrate 121 facing the array substrate 110, and the anti-overflow structure 122 includes an anti-overflow groove 1227 formed in the planarization layer 126 and recessed toward the second base substrate 121. The anti-overflow groove 1227 can accommodate a certain volume of the liquid crystal, which can effectively prevent the liquid crystal from diffusing to the frame sealing adhesive 140, and can further prevent the liquid crystal from impacting the frame sealing adhesive 140, thereby solving the puncture problem and improving the yield of products. In addition, the design of the anti-overflow groove 1227 can make the liquid crystal droplet have good fluidity, so that the liquid crystal can be better filled in the display region AA. For example, the planarization layer 126 may be an outermost layer of the opposite substrate 120 facing the array substrate 110.

In some examples, as illustrated by FIG. 13, the anti-overflow groove 1227 may be a closed structure surrounding the display region AA, so that the liquid crystal can be prevented from diffusing to the frame sealing adhesive 140 more effectively, and the impact of the liquid crystal on the frame sealing adhesive 140 can also be better prevented.

In some examples, as illustrated by FIG. 13, a depth D6 of the anti-overflow groove 1227 is in a range from 0.5 μm to 1.5 μm, and a width D7 of the anti-overflow groove 1227 is in a range from 200 μm to 400 μm. By reasonably setting the depth D6 and width D7 of the anti-overflow groove 1227, the anti-overflow groove 1227 can have a relatively large accommodating volume.

In some examples, as illustrated by FIG. 13, the depth D6 of the anti-overflow groove 1227 may be 40% to 60% of a thickness of the planarization layer 126. According to the actual product and the material and thickness of the planarization layer 126, the anti-overflow groove 1227 can have a relatively large accommodating volume by reasonably designing and verifying the depth D6 of the anti-overflow groove 1227.

In some examples, as illustrated by FIG. 13, the opposite substrate 120 further includes the black matrix layer 124 and the color film layer 125, which are located between the second base substrate 121 and the planarization layer 126. For example, the opposite substrate 120 may further include the peripheral spacer, as illustrated by FIG. 2 for details, and will not be described again here.

In some examples, as illustrated by FIG. 13, the color film layer 125 is located on a side of the anti-overflow structure 122 close to the display region AA. Therefore, the anti-overflow groove 1227 can have a relatively large accommodating volume.

In some examples, as illustrated by FIG. 13, the material of the planarization layer 126 may be photoresist. Of course, the embodiment of the present disclosure does not limit the material of the planarization layer 126. For example, the planarization layer 126 may also be another functional layer on the opposite substrate 120, and the functional layer further has a planarization function.

The embodiment of the present disclosure does not limit the material of the anti-overflow structure 122. For example, the material of the anti-overflow structure 122 may be the same as the material of the color film layer 125, or the same as the material of the planarization layer 126, or the same as the material of the conductive layer on the opposite substrate 120.

It is worth noting that, although the above-mentioned embodiments respectively illustrate the case that the anti-overflow structure is an anti-overflow cofferdam and the case that the anti-overflow structure is an anti-overflow groove, the embodiments of the present disclosure include but are not limited thereto, and the anti-overflow structure may include both the anti-overflow cofferdam and the anti-overflow groove. FIG. 14 is a schematic diagram of an anti-overflow structure of another opposite substrate provided by an embodiment of the present disclosure. As illustrated by FIG. 14, the anti-overflow structure of the opposite substrate of the liquid crystal display panel includes the anti-overflow cofferdam and the anti-overflow groove. For example, the anti-overflow groove is disposed on a side of the anti-overflow cofferdam close to the display region. Therefore, the liquid crystal display panel can have the beneficial technical effects of anti-overflow groove and anti-overflow cofferdam at the same time, which will not be described again here. The anti-overflow cofferdam of the liquid crystal display panel may be any of the anti-overflow cofferdams mentioned above, and the anti-overflow groove of the liquid crystal display panel may be any of the anti-overflow grooves mentioned above.

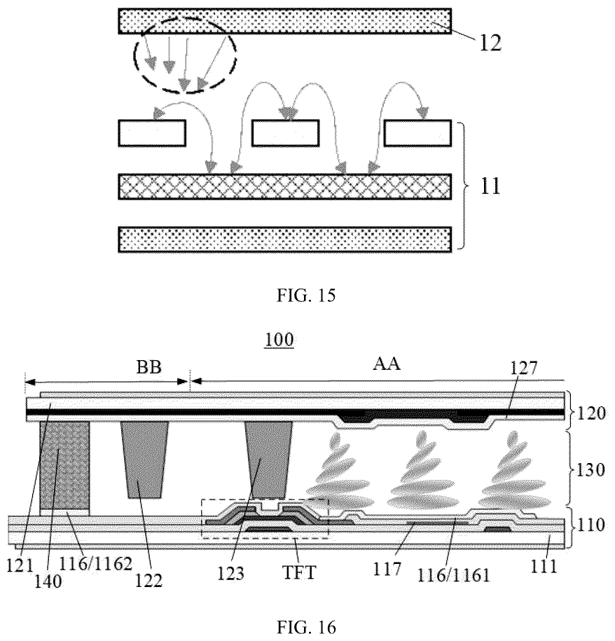

FIG. 15 is a schematic diagram of static electricity on an opposite substrate of a liquid crystal display panel. As illustrated by FIG. 15, if there is no metal at a side of the opposite substrate 12 facing the array substrate 11, the static electricity on the opposite substrate 12 cannot be diffused and is easily accumulated. As shown by arrows circled by a dotted line in the figure, especially the display region of the miniaturized liquid crystal display panel is relatively small, and the liquid crystal between the opposite substrate 12 and the array substrate 11 is more easily influenced by the static electricity, which will cause the initial orientation of the liquid crystal to be abnormal, resulting in uneven display, and will also reduce the contrast and transmittance of the liquid crystal display panel.

FIG. 16 is a schematic cross-sectional view of a liquid crystal display panel according to an embodiment of the present disclosure. As illustrated by FIG. 16, the opposite substrate 120 of the liquid crystal display panel 100 further includes an electrostatic discharge layer 127, which is disposed on a side of the second base substrate 121 facing the array substrate 110. The frame sealing adhesive 140 is at least partially connected with the electrostatic discharge layer 127, and the frame sealing adhesive 140 is configured to have conductivity so that the electrostatic discharge layer 127 is connected with the array substrate 110 through the frame sealing adhesive 140.

In the liquid crystal display panel 100 of the embodiment of the present disclosure, the liquid crystal droplet is dripped on the opposite substrate 120, and the opposite substrate 120 is provided with the anti-overflow structure 122, which can avoid the overflow of the liquid crystal and the impact of the liquid crystal on the frame sealing adhesive 140. The electrostatic discharge layer 127 is formed on the opposite substrate 120, and the electrostatic discharge layer 127 is connected with the array substrate 110 through the conductive frame sealing adhesive 140, so that the static electricity on the opposite substrate 120 can be discharged through the electrostatic discharge layer 127, so as to prevent the static electricity on the opposite substrate 120 from affecting the liquid crystal dripped on the opposite substrate 120, avoid the abnormal orientation of the liquid crystal, and improve the display performance of the liquid crystal display panel 100.

It should be noted that, the embodiments of the present disclosure do not limit the form of the anti-overflow structure 122, which can be any of the above-mentioned anti-overflow structures 122. The embodiments of the present disclosure also do not limit the arrangement of the structures or the films of the opposite substrate 120, which can be any of the above-mentioned opposite substrates 120.

In some examples, as illustrated by FIG. 16, the electrostatic discharge layer 127 may be a whole conductive layer disposed on the opposite substrate 120. For example, in the plane parallel to the second base substrate 121, the electrostatic discharge layer 127 may have the same size as that of the second base substrate 121. The electrostatic discharge layer 127 with a large area can diffuse the static electricity on the opposite substrate 120, and the static electricity is not easy to accumulate in a large amount to cause poor display. In addition, the whole layer of electrostatic discharge layer 127 does not need mask cost, and the cost can be reduced. Of course, the embodiment of the present disclosure does not limit the shape of the electrostatic discharge layer 127, which may be set as a whole layer, or may be designed to have a hollowed-out part at a position corresponding to the pixel structure, according to the performance requirements of actual products.

For example, a material of the electrostatic discharge layer 127 may be a transparent conductive material, and for example, the material of the electrostatic discharge layer 127 may be indium tin oxide.

For example, a thickness of the electrostatic discharge layer 127 is in a range from 200 angstroms to 500 angstroms.

For example, the frame sealing adhesive 140 may contain conductive gold balls or silver balls to be conductive.

In some examples, as illustrated by FIG. 16, the array substrate 110 of the liquid crystal display panel 100 further includes a common electrode layer 116, which is disposed on a side of the first base substrate 111 facing the opposite substrate 120, and includes a common electrode 1161 located in the display region AA and a conductive structure 1162 located in the peripheral region BB, and the frame sealing adhesive 140 is at least partially connected with the conductive structure 1162. Therefore, the electrostatic discharge layer 127 can be connected with the conductive structure 1162 of the common electrode layer 116 through the conductive frame sealing adhesive 140 to discharge the electrostatic on the opposite substrate 120.

In this embodiment, the pixel structure on the array substrate 110 includes the common electrode 1161, a pixel electrode 117 and a driving transistor TFT. For example, the driving transistor TFT may be connected to the pixel electrode 117 to realize the deflection of the liquid crystal.

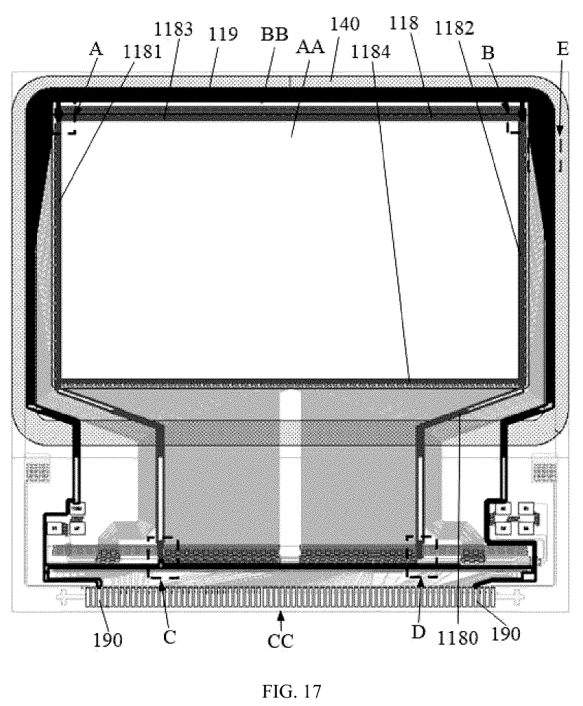

FIG. 17 is a partial structural diagram of a liquid crystal display panel of FIG. 16. As illustrated by FIGS. 16 and 17, the array substrate 110 of the liquid crystal display panel 100 further includes a first common electrode line 118 surrounding the display region AA and a second common electrode line 119 surrounding the first common electrode line 118, the first common electrode line 118 is connected with the second common electrode line 119, the first common electrode line 118 is connected with the common electrode 1161 of the display region AA, and the second common electrode line 119 is connected with a signal input port 199 of the liquid crystal display panel 100, the array substrate 110 further includes a via hole, and the second common electrode line 119 is connected to the conductive structure 1162 through the via hole. In this example, the electrostatic discharge layer 127 is connected to the second common electrode line 119 sequentially through the conductive frame sealing adhesive 140 and the conductive structure 1162 of the common electrode layer 116, and the second common electrode line 119, the first common electrode line 118 and the common electrode 1161 of the display region AA are connected, so that the electrostatic discharge layer 127 has a same voltage signal as the common electrode 1161 of the display region AA. There is no vertical electric field between the electrostatic discharge layer 127 and the common electrode 1161 of the display region AA, so that the influence of electrical potential difference between the electrostatic discharge layer 127 and the common electrode 1161 on the deflection of the liquid crystal can be further avoided. Moreover, connecting the electrostatic discharge layer 127 to the second common electrode line 119 does not require additional circuit design. The liquid crystal display panel illustrated by FIG. 17 will be described in detail below.

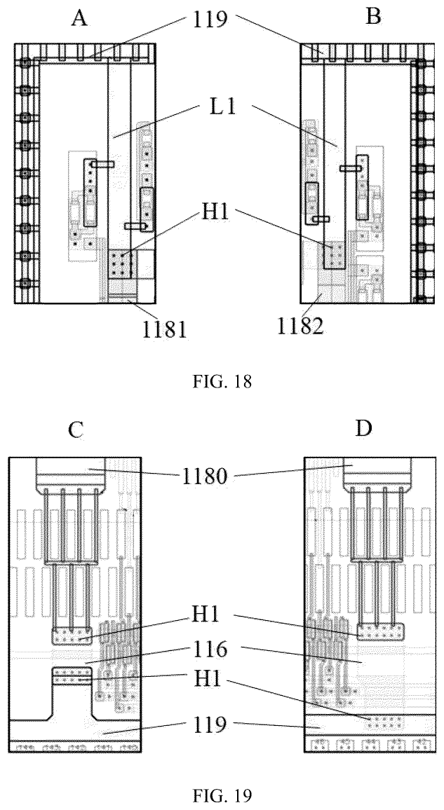

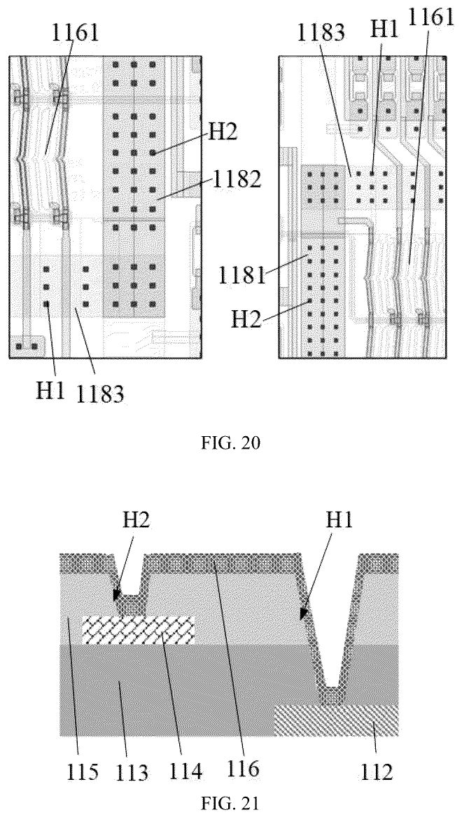

FIG. 18 is a partial enlarged view of FIG. 17 at positions A and B; FIG. 19 is a partial enlarged view of FIG. 17 at positions C and D; FIG. 20 is a partial enlarged view of FIG. 17; FIG. 21 is a schematic cross-sectional view illustrating connection of conductive layers of FIG. 17. As illustrated by FIGS. 17 to 21, the first common electrode line 118 and the second common electrode line 119 are connected at positions A, B, C and D.

In some examples, as illustrated by FIGS. 16 and 21, the array substrate 110 of the liquid crystal display panel 100 includes a first conductive layer 112 disposed on a side of the first base substrate 111 facing the opposite substrate 120 and a second conductive layer 114 disposed on a side of the first conductive layer 112 facing the opposite substrate 120, and the first conductive layer 112 and second conductive layer 114 are located between the first base substrate 111 and the common electrode layer 116. A first insulating layer 113 is disposed between the first conductive layer 112 and the second conductive layer 114, and a second insulating layer 115 is disposed between the second conductive layer 114 and the common electrode layer 116. For example, the first conductive layer 112 is arranged in a same layer as a gate layer of the pixel structure of the display region AA, and the second conductive layer 114 is arranged in a same layer as a source and drain conductive layer of the pixel structure, the first insulating layer 113 may be a gate insulating layer and the second insulating layer 115 may be a passivation layer.

In some examples, as illustrated by FIGS. 17, 18, 20 and 21, the second common electrode line 119 is connected to the first common electrode line 118 through a lead L1 at positions A and B. The second common electrode line 119 and the lead L1 are located in the first conductive layer 112, an upper edge 1183 and a lower edge 1184 of the first common electrode line 118 are located in the first conductive layer 112, and a left edge 1181 and a right edge 1182 of the first common electrode line 118 are located in the second conductive layer 114. The upper edge 1183 and the lower edge 1184 of the first common electrode line 118 are connected to the common electrode layer 116 through a via hole H1, and the left edge 1181 and the right edge 1182 of the first common electrode line 118 are connected to the common electrode layer 116 through a via hole H2, so that the first common electrode line 118 is connected to the common electrode 1161 of the display region AA. The lead L1 of the second common electrode line 119 is connected to the common electrode layer 116 through the via hole H1, so that the first common electrode line 118 and the second common electrode line 119 are connected, and the first common electrode line 118, the second common electrode line 119 and the common electrode 1161 of the display region AA have the same voltage signal. Of course, the embodiment of the present disclosure does not limit the conductive layers where the first common electrode line 118 and the second common electrode line 119 are located.

It should be noted that, FIG. 21 only schematically shows that the first conductive layer 112 and the common electrode layer 116 are connected through the via hole H1, and the second conductive layer 114 and the common electrode layer 116 are connected through the via hole H2, which does not limit the positions and numbers of the via hole H1 and the via hole H2, nor does it limit the traces in the first conductive layer 112 and the second conductive layer 114. According to different traces, connected positions and sizes of the positions, a required number of via holes are set at corresponding positions.

In some examples, as illustrated by FIGS. 17, 19 and 21, the first common electrode line 118 further includes a connection line 1180 extending from the display region AA, and the connection line 1180 may be located in the first conductive layer 112. In positions C and D, because there are other signal lines between the first common electrode line 118 and the second common electrode line 119, in order to avoid the other signal lines, the second common electrode line 119 is connected with the first common electrode line 118 through the common electrode layer 116, and the second common electrode line 119 located in the first conductive layer 112 is connected with the common electrode layer 116 through the via hole H1, the first common electrode line 118 located in the first conductive layer 112 is connected with the common electrode layer 116 through the via hole H1, therefore, the first common electrode line 118 and the second common electrode line 119 are connected.

In some examples, as illustrated by FIG. 17, the second common electrode line 119 is connected to the signal input port 190 of the liquid crystal display panel 100 in a bonding region CC, so that the common voltage signal can be provided for the common electrode 1161 and the electrostatic discharge layer 127 through the second common electrode line 119.

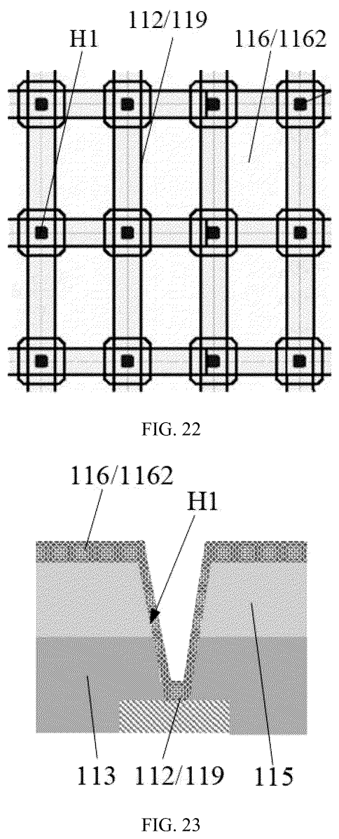

FIG. 22 is a partial enlarged view of FIG. 17 at position E; FIG. 23 is a schematic cross-sectional view of FIG. 22. As illustrated by FIG. 17, FIG. 22 and FIG. 23, the second common electrode line 119 located in the first conductive layer 112 is connected with the conductive structure 1162 of the common electrode layer 116 through the via hole H1, so that the electrostatic discharge layer 127 is connected with the second common electrode line 119, and further, the electrostatic discharge layer 127 and the common electrode 1161 of the display region AA have the same voltage signal.

In some examples, as illustrated by FIG. 17, a shape of the conductive structure 1162 may be the same as a shape of the second common electrode line 119, in a region surrounded by an outermost boundary of the frame sealing adhesive 140, so that the second common electrode line 119 can be better connected with the conductive structure 1162 and the frame sealing adhesive 140. Of course, the embodiment of the present disclosure does not limit the shape of the conductive structure 1162, as long as the conductive structure 1162 can realize the connection between the second common electrode line 119 and the frame sealing adhesive 140.

In some examples, as illustrated by FIG. 17, FIG. 18 and FIG. 22, the second common electrode line 119 may be a metal grid line, so that a region where an orthogonal projection of the frame sealing adhesive 140 on the first base substrate 111 overlaps with an orthogonal projection of the metal grid line on the first base substrate 111 has better transmittance, which is convenient for curing of the frame sealing adhesive 140. Of course, the present disclosure does not limit the form of the second common electrode line 119.

In the embodiment of the present disclosure, the first common electrode line 118 and the second common electrode line 119 are connected, however, the first common electrode line 118 and the second common electrode line 119 may not be connected, and the first common electrode line 118 may be independently connected with a signal port of the liquid crystal display panel 100 to provide a common voltage signal to the first common electrode line 118, the common voltage signal may be the same as the voltage signal of the second common electrode line 119, thereby making the electrostatic discharge layer 127 and the common electrode 1161 have the same voltage signal. The embodiment of the present disclosure does not limit the connection form and the connection position of the first common electrode line 118 and the second common electrode line 119.

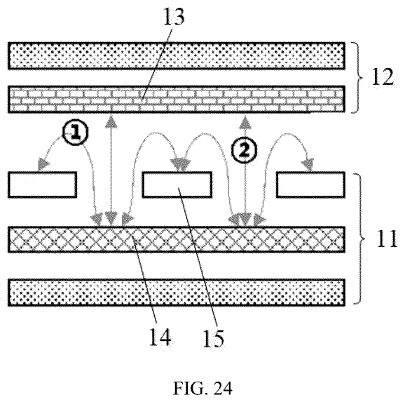

FIG. 24 is a schematic electric field diagram of a liquid crystal display panel. As illustrated by FIG. 24, a conductive layer 13 at an inner side of an opposite substrate 12 and a pixel electrode 14 of an array substrate 11 form a vertical electric field 2) and other coupled electric fields, which interfere with an electric field 1 between a common electrode 15 and a pixel electrode 14 for driving the deflection of the liquid crystal, and eventually lead to a decrease in pixel transmittance.

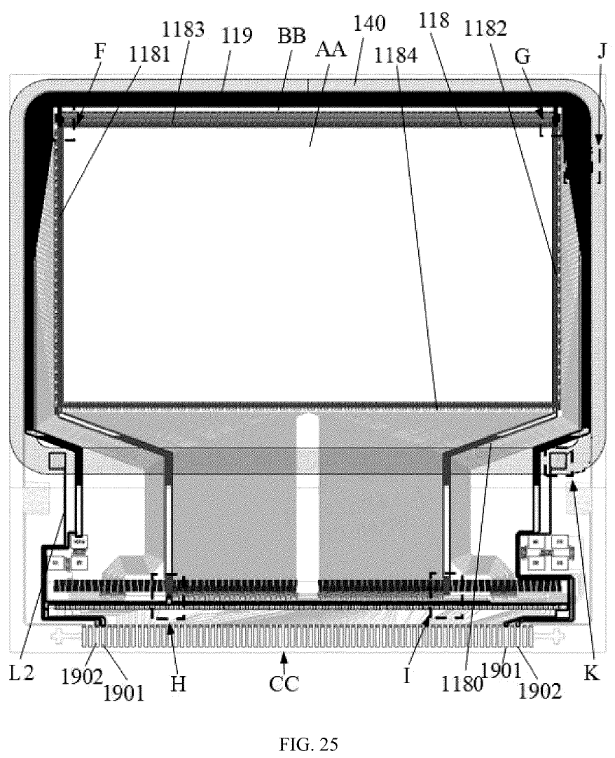

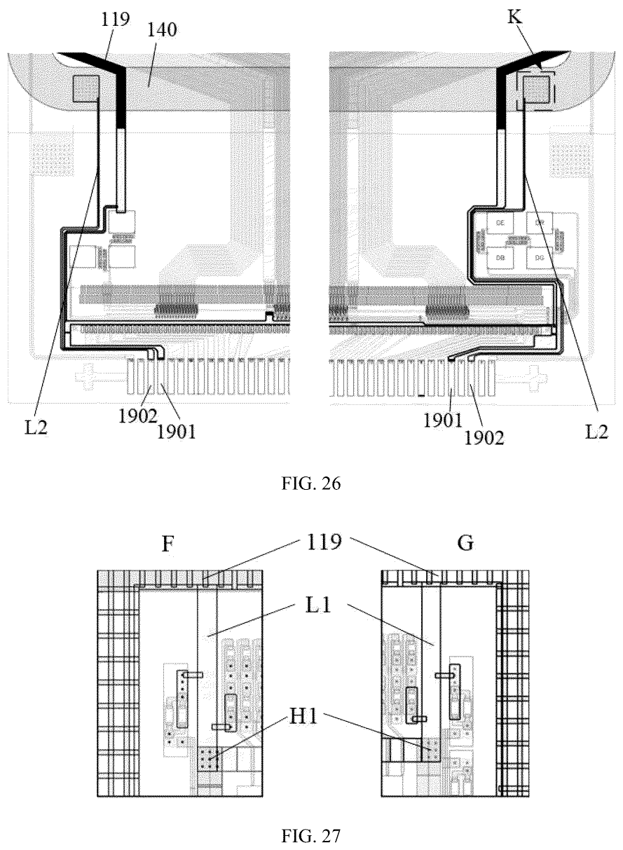

FIG. 25 is a partial structural diagram of another liquid crystal display panel of FIG. 16; FIG. 26 is a partially enlarged schematic view of FIG. 25. As illustrated by FIGS. 16, 25 and 26, the array substrate 110 further includes the first common electrode line 118 surrounding the display region AA and the second common electrode line 119 surrounding the first common electrode line 118, the first common electrode line 118 is connected with the second common electrode line 119 and connected with the common electrode 1161 of the display region AA. The second common electrode line 119 is connected to a first signal input port 1901 of the liquid crystal display panel 100 to be supplied with a first voltage signal, and the conductive structure 1162 is connected to a second signal input port 1902 of the liquid crystal display panel 100 through a lead L2 to be supplied with a second voltage signal.

In this example, the electrostatic discharge layer 127 is connected to the second signal input port 1902 sequentially through the conductive frame sealing adhesive 140, the conductive structure 1162 of the common electrode layer 116 and the lead L2, so as to be supplied with the second voltage signal, and the common electrode 1161 of the display region AA is connected to the first signal input port 1901 sequentially through the first common electrode line 118 and the second common electrode line 119, so as to be supplied with the first voltage signal. As such, voltage signals may be respectively provided to the electrostatic discharge layer 127 and the common electrode 1161 so that the electrostatic discharge layer 127 and the common electrode 1161 are controlled independently. For example, different or the same voltage signals can be set through software simulation to improve the performance such as transmittance or contrast.

For example, a difference between the first voltage signal and the second voltage signal is in a range from 0 to 3 V. Of course, the embodiment of present disclosure does not limit the first voltage signal and the second voltage signal and the difference therebetween, and according to the actual product size, structural design, cost and user demand and other factors, different voltage signals are matched to meet the requirements.

FIG. 27 is a partial enlarged view of FIG. 25 at positions F and G. As illustrated by FIG. 25 and FIG. 27, the first common electrode line 118 and the second common electrode line 119 are connected at position F, position G, position H and position I, and the connection modes of the four positions are the same as those of the embodiment of FIG. 17, and the partial enlarged views of position H and position I are the same as the partial enlarged views of FIG. 19, which will not be repeated. In addition, the connection mode between the first common electrode line 118 and the common electrode 1161 of the display region AA is also the same as that illustrated in the above-mentioned embodiment of FIG. 17, and the description will not be repeated. Of course, the embodiment of the present disclosure is not limited to the above-mentioned connection mode, and can be adaptively adjusted according to the actual wiring situation.

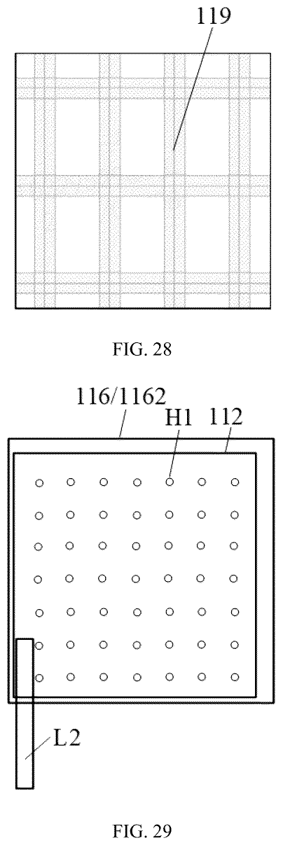

FIG. 28 is a partial enlarged view of FIG. 25 at position J. As illustrated by FIGS. 25 and 28, as is different from the partial enlarged view at the position E of FIG. 22, the second common electrode line 119 located in the first conductive layer 112 of this embodiment is not connected to the conductive structure 1162 of the common electrode layer 116 through the via hole H1, so that the second common electrode line 119 is not connected to the electrostatic discharge layer 127.

In some examples, as illustrated by FIG. 25, FIG. 27 and FIG. 28, the second common electrode line 119 may be a metal grid line, so that a region where an orthogonal projection of the frame sealing adhesive 140 on the first base substrate 111 overlaps with an orthogonal projection of the second common electrode line 119 on the first base substrate 111 has better transmittance, which is convenient for curing of the frame sealing adhesive 140. Of course, the present disclosure does not limit the form of the second common electrode line 119

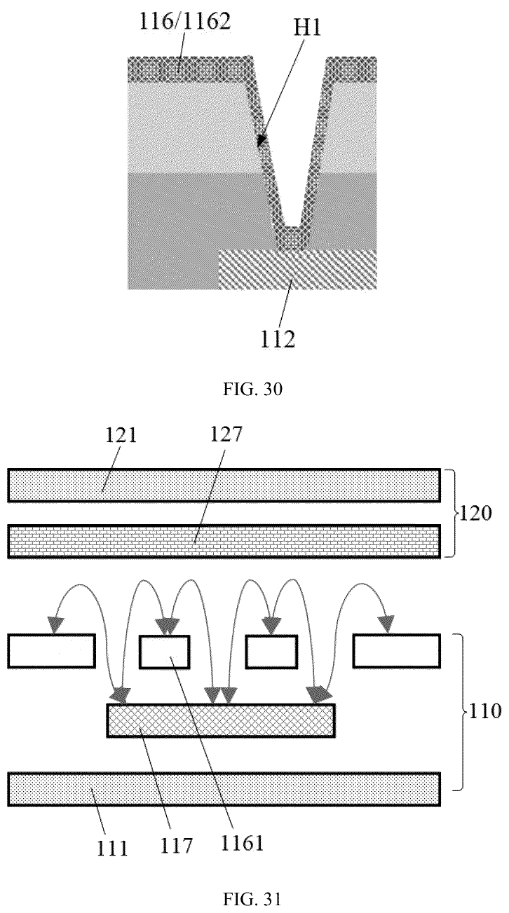

FIG. 29 is a partial enlarged view of FIG. 25 at position K; FIG. 30 is a schematic cross-sectional view of FIG. 28. As illustrated by FIG. 25, FIG. 26, FIG. 29 and FIG. 30, the conductive structure 1162 in the common electrode layer 116 is connected with the first conductive layer 112 through the via hole H1, the first conductive layer 112 is provided with the lead L2 and the second signal input port 1902 of the liquid crystal display panel 100, and the electrostatic discharge layer 127 is connected to the second signal input port 1902 sequentially through the conductive frame sealing adhesive 140, the conductive structure 1162 and the lead L2 of the first conductive layer 112, so as to be supplied with the second voltage signal, so that the electrostatic discharge layer 127 can be controlled independently. Of course, the embodiment of present disclosure does not limit the conductive layer where the lead L2 is located, nor does it limit the shape of the conductive structure 1162 or the number of the via holes H2.

In some examples, as illustrated by FIG. 25 and FIG. 26, in the plane parallel to the second base substrate 121, the conductive structure 1162 is located on a side of the second common electrode line 119 away from the display region AA and on a side of the second common electrode line 119 close to the signal input port of the liquid crystal display panel 100, so that the conductive structure 1162 and the lead L2 can be arranged more conveniently. Of course, the embodiment of present disclosure does not limit the positions and extension trends of the conductive structure 1162 and the lead L2, which can be reasonably arranged and designed according to the actual product. For example, as illustrated by FIGS. 25 and 26, the lead L2 may extend to the second signal input port 1902 substantially along the second common electrode line 119.

In some examples, as illustrated by FIGS. 25 and 26, the second signal input port 1902 is closer to an end of the bonding area CC than the first signal input port 1901 to the end of the bonding area CC. Of course, the embodiment of present disclosure does not limit the positions of the first signal input port 1901 and the second signal input port 1902, which can be reasonably arranged and designed according to actual products.

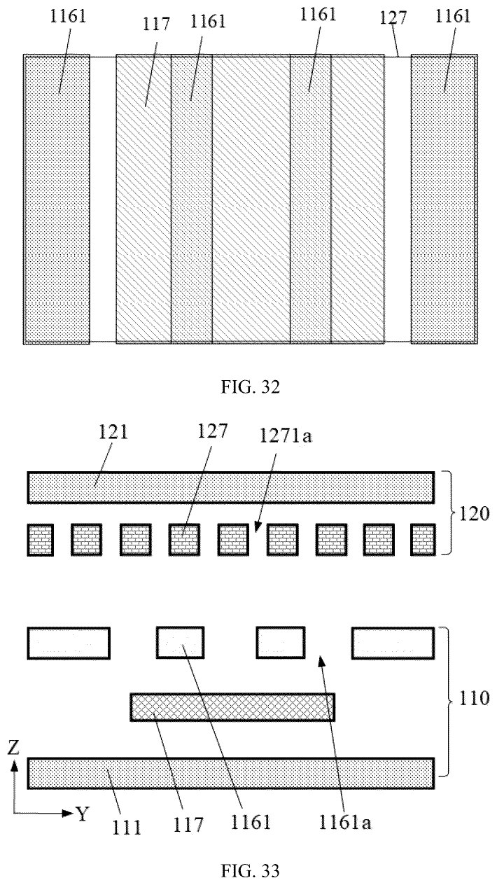

FIG. 31 is a schematic partial sectional view of another liquid crystal display panel provided by an embodiment of the present disclosure; FIG. 32 is a schematic partial top view of a corresponding pixel structure in FIG. 31. As illustrated by FIG. 31 and FIG. 32, the opposite substrate 120 layer of the liquid crystal display panel is provided with a whole layer of the electrostatic discharge layer 127, which may have the same voltage signal as the common electrode 1161 of the array substrate 110 or a different voltage signal from the common electrode 1161 of the array substrate 110. In this embodiment, the whole layer of the electrostatic discharge layer 127 can disperse and lead out charges to the greatest extent, so as to avoid the influence of the charges on the liquid crystal.

In some examples, as illustrated by FIG. 31, the array substrate 110 further includes a plurality of pixel electrodes 117 corresponding to a plurality of common electrodes 1161, and the pixel electrodes 117 of the pixel structure may be block-shaped pixel electrodes.

The display performances of the liquid crystal display panel with the whole layer of the electrostatic discharge layer and a liquid crystal display panel without the electrostatic discharge layer are simulated and analyzed. For the liquid crystal display panel without the electrostatic discharge layer, when simulating a transmittance of L255, a voltage V3 of the pixel electrode is 98% of a working voltage, and the voltage V3 is 4.1 V; when simulating a transmittance of L0, the voltage V3 of the pixel electrode is 0% of the working voltage, and the voltage V3 is 0 V; when simulating a transmittance at L127 grayscale, the voltage V3 of the pixel electrode is 2.36 V. In this embodiment, the electrostatic discharge layer and the common electrode have the same voltage signal.

According to the simulation verification, at L0 grayscale, compared with the liquid crystal display panel without the electrostatic discharge layer, the transmittance of the liquid crystal display panel is reduced by 0.56% after adding the electrostatic discharge layer, so the liquid crystal display panel is blacker in normally black mode after adding the electrostatic discharge layer. At L127 grayscale, compared with the liquid crystal display panel without the electrostatic discharge layer, the voltage of the pixel electrode is reduced from 2.36V to 2.12 V, thus reducing power consumption. At L255 grayscale, compared with the liquid crystal display panel without the electrostatic discharge layer, the transmittance of the liquid crystal display panel is greatly lost, which is reduced by 40.4%. Therefore, setting the whole layer of the electrostatic discharge layer can be applied to products with low requirements for transmittance but high requirements for appearance and power consumption.

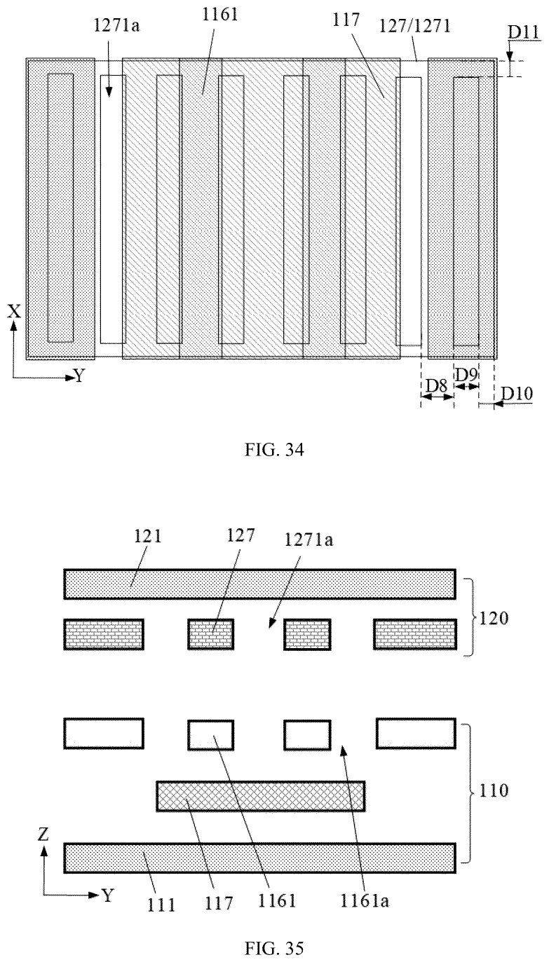

FIG. 33 is a schematic partial sectional view of another liquid crystal display panel 100 according to an embodiment of the present disclosure; FIG. 34 is a schematic partial top view of a corresponding pixel structure in FIG. 33. As illustrated by FIGS. 33 and 34, the plurality of pixel structures are arranged along a first direction X and a second direction Y, and the second direction Y intersects with the first direction X. In one pixel structure, the common electrode 1161 includes a plurality of first slots 1161a extending along the first direction X and arranged along the second direction Y. The electrostatic discharge layer 127 includes a plurality of electrostatic discharge portions 1271 corresponding to the plurality of pixel structures, and each electrostatic discharge portion 1271 includes a plurality of second slots 1271a extending along the first direction X and arranged along the second direction Y. By arranging the second slot 1271a at a position of the electrostatic discharge layer 127 corresponding to the pixel structure, the static electricity in the opposite substrate 120 can be effectively dispersed and led out, and the transmittance of the liquid crystal display panel 100 can be improved. In this example, the electrostatic discharge layer 127 may have the same voltage signal as the common electrode 1161 of the array substrate 110 or a different voltage signal from the common electrode 1161 of the array substrate 110.

In some examples, as illustrated by FIGS. 33 and 34, in one pixel structure, the plurality of second slots 1271a are arranged at equal intervals, and in the second direction Y, a ratio of a dimension D8 between two adjacent second slots 1271a to a dimension D9 of the second slot 1271a is in a range from 1.0 to 1.5. Therefore, the dimension D9 of the second slot 1271a in the second direction Y can be appropriately reduced, and a ratio of a conductive area of the electrostatic discharge portion 1271 to a total area surrounded by the electrostatic discharge portion 1271 may be greater than 50%, so that the static electricity on the opposite substrate 120 can be better dispersed and led out on the basis of improving the transmittance. It should be noted that the total area surrounded by the electrostatic discharge portion 1271 refers to a sum of the conductive area of the electrostatic discharge portion 1271 and areas of all the second slots 1271a of the electrostatic discharge portion 1271, that is, a total area surrounded by an outermost boundary of the electrostatic discharge portion 1271.

For example, by setting the dimension between the second slots 1271a and the dimension of the second slots 1271a, the ratio of the conductive area of the electrostatic discharge portion 1271 to the total area surrounded by the electrostatic discharge portion 1271 may be between 50% and 65%, so that the electrostatic discharge layer 127 can better disperse and lead out static electricity on the opposite substrate 120 on the basis of improving the transmittance.

In some examples, as illustrated by FIG. 34, in the second direction Y, the dimension D8 between two second slots 1271a may be in a range from 2 μm to 3 μm. For example, in the second direction Y, a dimension D10 of an edge position of the electrostatic discharge portion 1271 is half of the dimension D8 between the two second slots 1271a.

In some examples, as illustrated by FIG. 34, the arrangement of the slots of the electrostatic discharge portion 1271 is symmetrical with respect to a center line of the electrostatic discharge portion 1271 along the first direction X and also symmetrical with respect to a center line of the electrostatic discharge portion 1271 along the second direction Y.

In some examples, as illustrated by FIG. 34, in the first direction X, the second slot 1271a does not penetrate through the electrostatic discharge portion 1271, and a minimum distance D11 between an end of the second slot 1271a and a boundary of the electrostatic discharge portion 1271 is greater than or equal to 1 μm. For example, the distance D11 may be in a range from 1 μm to 1.5 μm.

In some examples, as illustrated by FIG. 33, the array substrate 110 further includes the plurality of pixel electrodes 117 corresponding to the plurality of common electrodes 1161, and the pixel electrodes 117 of the pixel structure may be block-shaped pixel electrodes.

The display performances of the liquid crystal display panel with the electrostatic discharge layer illustrated by FIG. 33 and a liquid crystal display panel without the electrostatic discharge layer are simulated and analyzed. A voltage of a pixel electrode of the liquid crystal display panel without the electrostatic discharge layer is the same as that described above, and will not be repeated here. In this embodiment, the electrostatic discharge layer and the common electrode have the same voltage signal.

According to the simulation verification, at L127 grayscale, compared with the liquid crystal display panel without the electrostatic discharge layer, the voltage of the pixel electrode is reduced from 2.36V to 2.16 V after adding the electrostatic discharge layer, which can reduce the power consumption. At L0 grayscale, the transmittance of the liquid crystal display panel is reduced by 3.18%, so the liquid crystal display panel is blacker in normally black mode after adding the electrostatic discharge layer. At L255 grayscale, the transmittance of the liquid crystal display panel is also lost, which is reduced by 34.54%. Compared with setting the whole layer of the electrostatic discharge layer, this embodiment is blacker in normally black mode, and the decrease of light transmittance is also alleviated at L255 grayscale.

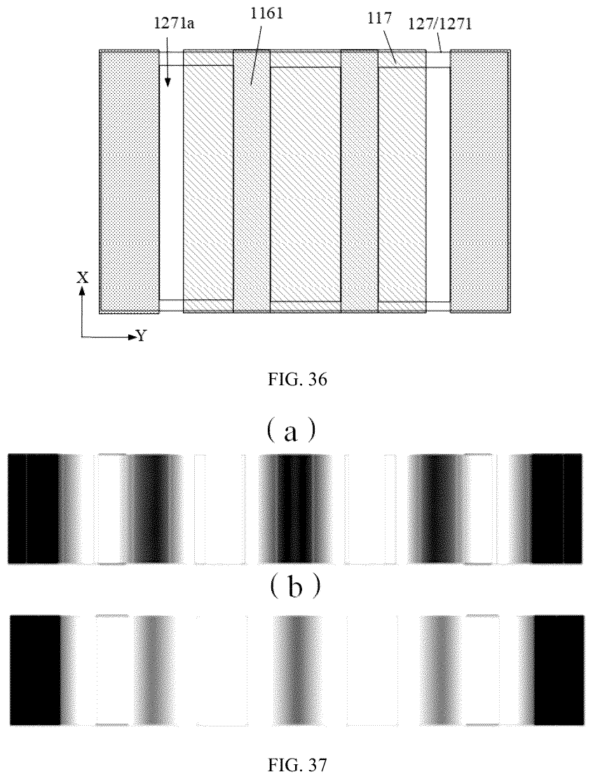

FIG. 35 is a schematic partial sectional view of another liquid crystal display panel provided by an embodiment of the present disclosure; FIG. 36 is a schematic partial top view of a corresponding pixel structure in FIG. 35. As illustrated by FIG. 35 and FIG. 36, in one pixel structure, the plurality of first slots 1161a and the plurality of second slots 1271a are arranged in one-to-one correspondence, and in the second direction Y, the dimensions of the first slot 1161a and the second slot1271a that are arranged in correspondence with each other are the same. By setting the dimensions of the first slot 1161a and the second slot 1271a in the second direction Y to be the same, the ratio of the conductive area of the electrostatic discharge portion 1271 to the total area surrounded by the electrostatic discharge portion 1271 may be less than 50%, and the ratio of the conductive area of the electrostatic discharge portion 1271 to the total panel surrounded by the electrostatic discharge portion 1271 may be appropriately reduced, so that the light efficiency of the pixel can be better and the transmittance can be better. In this example, the electrostatic discharge layer 127 may have the same voltage signal as the common electrode 1161 of the array substrate 110 or a different voltage signal from the common electrode 1161 of the array substrate 110.

In some examples, as illustrated by FIGS. 35 and 36, the array substrate 110 further includes the plurality of pixel electrodes 117 corresponding to the plurality of common electrodes 1161, and the pixel electrodes 117 of the pixel structure may be block-shaped pixel electrodes.

The display performances of the liquid crystal display panel with the electrostatic discharge layer illustrated by FIG. 35 and a liquid crystal display panel without the electrostatic discharge layer are simulated and analyzed. A voltage of a pixel electrode of the liquid crystal display panel without the electrostatic discharge layer is the same as that described above, and will not be repeated here. In this embodiment, the electrostatic discharge layer and the common electrode have the same voltage signal.

According to the simulation verification, at L127 grayscale, compared with the liquid crystal display panel without the electrostatic discharge layer, the voltage of the pixel electrode is reduced from 2.36V to 2.17 V after adding the electrostatic discharge layer in the liquid crystal display panel, which can reduce the power consumption. At L0 grayscale, the transmittance of the liquid crystal display panel is reduced by 0.58%, so the liquid crystal display panel is blacker in normally black mode after adding the electrostatic discharge layer. At L255 grayscale, the loss of the transmittance of the liquid crystal display panel is very small, which is reduced by 8.44%, compared with the corresponding solutions in FIGS. 31 and 33, the transmittance is greatly improved. Therefore, this embodiment can be used not only for products with higher requirements on appearance and power consumption, but also for products with higher requirements on transmittance.

FIG. 37 is a light effect diagram of two solutions at L255 grayscale according to the embodiment of the present disclosure. As illustrated by FIG. 37, (a) corresponds to a light effect diagram of FIG. 33, (b) corresponds to a light effect diagram of FIG. 35, and (b) has a greater transmittance than (a) at L255 grayscale.

In the liquid crystal display panel illustrated by FIG. 31, the electrostatic discharge layer 127 may be connected to an independent signal input port through the lead, and the common electrode 1161 is connected to another signal input port through the first common electrode line or the second common electrode line, so that the voltage signals of the electrostatic discharge layer 127 and the common electrode 1161 can be controlled independently.

The display performance of the liquid crystal display panel with the electrostatic discharge layer illustrated by FIG. 31 and a liquid crystal display panel without the electrostatic discharge layer are simulated and analyzed. A voltage of a pixel electrode of the liquid crystal display panel without an electrostatic discharge layer is the same as that described above, and will not be repeated here. In this example, a voltage of the electrostatic discharge layer is V1, a voltage of the common electrode is V2, and a voltage of the pixel electrode is V3, and V1-V2 represents a difference between the voltage V1 and the voltage V2. In this embodiment, the voltage signals of the electrostatic discharge layer and the common electrode are independently controlled.

At L0 grayscale, the value of V1-V2 may be in a range from 1.7 V to 1.9 V, or the value of V1-V2 may be in a range from −1.8 V to −1.6 V. For example, the value of V1-V2 may be 1.8 V or −1.8V. In the case that the voltage V3 of the pixel electrode is set to be 0 V, the transmittance of the liquid crystal display panel is reduced by 72.2%, so that the liquid crystal display panel is blacker in the normally black mode, the transmittance is more obviously reduced compared with the above-described embodiment, and the contrast is greatly improved compared with the case without the electrostatic discharge layer. For example, it can be used for products with high requirements at L0 grayscale and high requirements for contrast.

At L255 grayscale, the value of V1-V2 may be in a range from 1.8 V to 2.0 V, for example, the value of V1-V2 may be 1.8 V. In the case that the voltage V3 of the pixel electrode is set to be 98% of the working voltage, the transmittance of the liquid crystal display panel only loses 6.48%, and the transmittance is greatly improved.

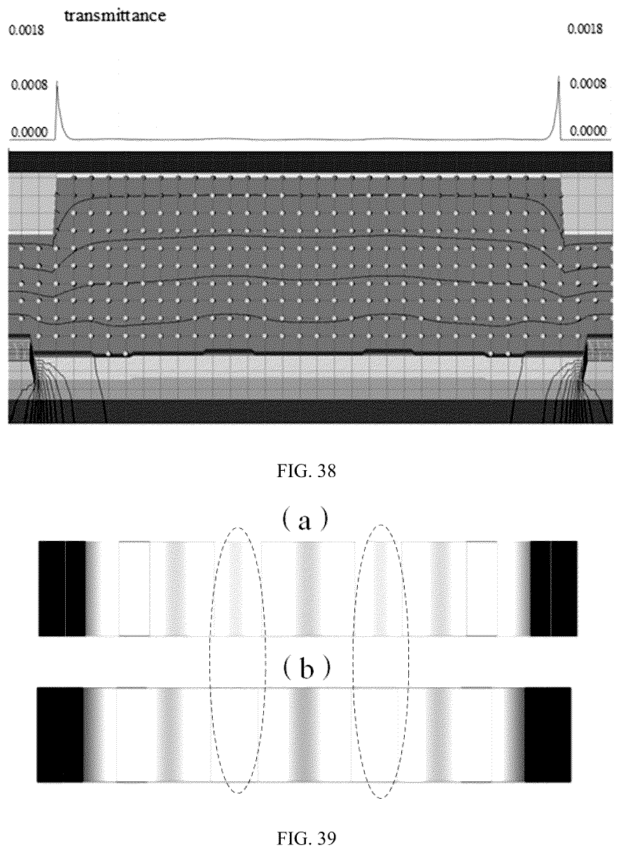

FIG. 38 is a schematic diagram of liquid crystal deflection simulation of a liquid crystal display panel illustrated by FIG. 31 at L0 grayscale. As illustrated by FIG. 38, at L0 grayscale, referring to the above voltage setting, the difference between the voltage V1 and the voltage V2 is 1.8 V, the liquid crystal is not deflected, and the liquid crystal is basically perpendicular to a paper surface, and the liquid crystal display panel is relatively dark in the normally black mode, and the transmittance curve also shows that the transmittance is basically 0 in this state, thus the contrast of the liquid crystal display panel is greatly improved.

In the liquid crystal display panel illustrated by FIG. 33, the electrostatic discharge layer 127 may be connected to an independent signal input port through the lead, and the common electrode 1161 is connected to another signal input port through the first common electrode line or the second common electrode line, so that the voltage signals of the electrostatic discharge layer 127 and the common electrode 1161 can be controlled independently.

The display performance of the liquid crystal display panel with the electrostatic discharge layer illustrated by FIG. 33 and a liquid crystal display panel without the electrostatic discharge layer are simulated and analyzed. A voltage of the pixel electrode of the liquid crystal display panel without the electrostatic discharge layer is the same as that described above, and will not be repeated here. In this example, the voltage of the electrostatic discharge layer is V1, the voltage of the common electrode is V2, and the voltage of the pixel electrode is V3, and V1-V2 represents the difference between the voltage V1 and the voltage V2. In this embodiment, the voltage signals of the electrostatic discharge layer and the common electrode are controlled independently.

At L0 grayscale, the value of V1-V2 may be in a range from −0.1 V to 0.1 V. For example, the value of V1-V2 may be 0 V, and the voltage of the electrostatic discharge layer is the same as the voltage of the common electrode. In the case that the voltage V3 of the pixel electrode is set to 0 V, the transmittance of the liquid crystal display panel decreases by 3.18%, so that the liquid crystal display panel is relatively dark in the normally black mode.

At L255 grayscale, the value of V 1-V2 may be in a range from 1.9 V to 2.1 V, for example, the value of V1-V2 may be 2 V. In the case that the voltage V3 of the pixel electrode is set to be 98% of the working voltage, the transmittance of the liquid crystal display panel only loses 3.88%.

In this embodiment, the electrostatic discharge layer can improve the transmittance at L0 grayscale and minimize the influence on the transmittance and the contrast at L255 grayscale.

In the liquid crystal display panel illustrated by FIG. 35, the electrostatic discharge layer 127 may be independently connected to the signal input port through the lead, and the common electrode is connected to another signal input port through the first common electrode line or the second common electrode line, so that the voltage signals of the electrostatic discharge layer 127 and the common electrode 1161 can be controlled independently.

The display performance of the liquid crystal display panel with the electrostatic discharge layer illustrated by FIG. 35 and a liquid crystal display panel without the electrostatic discharge layer are simulated and analyzed. A voltage of the pixel electrode of the liquid crystal display panel without the electrostatic discharge layer is the same as that described above, and will not be repeated here. In this example, the voltage of the electrostatic discharge layer is V1, the voltage of the common electrode is V2, and the voltage of the pixel electrode is V3, and V1-V2 represents the difference between the voltage V1 and the voltage V2. In this embodiment, the voltage signals of the electrostatic discharge layer and the common electrode are independently controlled.

At L0 grayscale, the value of V1-V2 may be in a range from 1.0 V to 1.2 V, or the value of V1-V2 may be in a range from −1.2 V to −1.0 V. For example, the value of V1-V2 may be 1.1 V or −1.1 V. In the case that the voltage V3 of the pixel electrode is set to be 0 V, the transmittance of the liquid crystal display panel decreases by 22.1%, so that the liquid crystal display panel is darker in the normally black mode.

At L255 grayscale, the value of V1-V2 may be in a range from 1.0 V to 1.3 V, for example, the value of V1-V2 may be 1.1 V. In the case that the voltage V3 of the pixel electrode is set to be 98% of the working voltage, the transmittance of the liquid crystal display panel only loses 2.59%, the transmittance is greatly improved.

FIG. 39 is a light effect diagram of a liquid crystal display panel illustrated by FIG. 35 at L255 grayscale. As illustrated by FIG. 39, (b) is a light effect diagram of a liquid crystal display panel illustrated by FIG. 35 at L255 grayscale, and (a) is a light effect diagram at L255 grayscale in the case that the electrostatic discharge layer of the liquid crystal display panel in (b) is removed, as shown by the dotted box in the figure, a number of dark regions of (b) is obviously reduced compared with a number of dark regions of (a), so that the contrast can be improved.

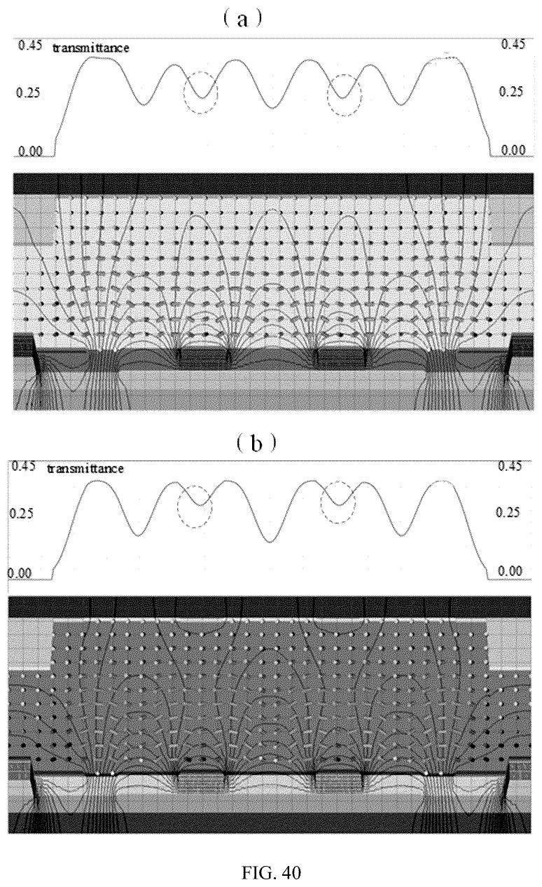

FIG. 40 is a schematic diagram of liquid crystal deflection simulation of a liquid crystal display panel illustrated by FIG. 35 at L255 grayscale. As illustrated by the FIG. 40, (b) is a liquid crystal deflection simulation diagram of a liquid crystal display panel illustrated by FIG. 35 at L255 grayscale, and (a) is a liquid crystal deflection simulation diagram at L255 grayscale in the case that the electrostatic discharge layer of the liquid crystal display panel in (b) is removed, as shown by the dotted box in the figure, the transmittance of (b) is greatly improved compared with the transmittance of (a), so that the contrast can be improved.

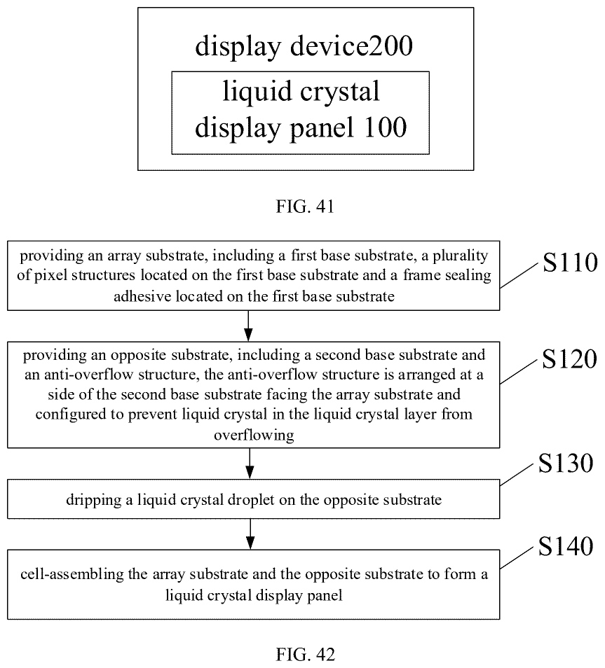

An embodiment of the present disclosure further provides a display device. FIG. 41 is a schematic diagram of a display device provided by an embodiment of the present disclosure. As illustrated by FIG. 41, the display device 200 includes the above-mentioned liquid crystal display panel 100.

For example, the display device 200 may be a television, a computer monitor, a notebook computer, a tablet computer, a smart phone, a navigator, an electronic picture frame, a vehicle display and other display devices with display functions.

An embodiment of the present disclosure further provides a manufacturing method of a liquid crystal display panel. FIG. 42 is a flowchart of a method for manufacturing a liquid crystal display panel according to an embodiment of the present disclosure. As illustrated by FIG. 42, the manufacturing method of the liquid crystal display panel includes the following steps.

S110: providing an array substrate, including a first base substrate, a plurality of pixel structures located on the first base substrate and a frame sealing adhesive located on the first base substrate.

S120: providing an opposite substrate, including a second base substrate and an anti-overflow structure, wherein the anti-overflow structure is disposed on a side of the second base substrate facing the array substrate and configured to prevent liquid crystal in the liquid crystal layer from overflowing.

S130: dripping a liquid crystal droplet on the opposite substrate.

S140: cell-assembling the array substrate and the opposite substrate to form a liquid crystal display panel, the liquid crystal display panel includes a display region and a peripheral region surrounding the display region, and the anti-overflow structure surrounds the display region and is disposed on a side of the frame sealing adhesive close to the display region. The anti-overflow structure is arranged on the opposite substrate, and the anti-overflow structure is disposed on a side of the frame sealing adhesive close to the display region, after the liquid crystal droplet is dripped on the opposite substrate, the anti-overflow structure can prevent the liquid crystal from overflowing, prevent the liquid crystal from diffusing to the boundary of the frame sealing adhesive, and prevent the diffusion of the liquid crystal from affecting the cell-assembling of the array substrate and the opposite substrate. In addition, the anti-overflow structure can further buffer the impact of the liquid crystal droplet on the frame sealing adhesive, solve the puncture problem and improve the yield of products.

The following statements should be noted:
(1) The drawings of the present disclosure involve only the structure(s) in connection with the embodiment(s) of the present disclosure, and other structure(s) can be referred to common design(s).
(2) In case of no conflict, features in one embodiment or in different embodiments can be combined to obtain new embodiments.

What have been described above are only specific implementations of the present disclosure, the protection scope of the present disclosure is not limited thereto. Any modifications or substitutions easily occur to those skilled in the art within the technical scope of the present disclosure should be within the protection scope of the present disclosure. Therefore, the protection scope of the present disclosure should be based on the protection scope of the claims.

1. A liquid crystal display panel, comprising an array substrate and an opposite substrate dispose opposite to each other, and a liquid crystal layer disposed between the array substrate and the opposite substrate, wherein the array substrate comprises a first base substrate and a plurality of pixel structures located on the first base substrate, the opposite substrate comprises:
a second base substrate; and
an anti-overflow structure, disposed on a side of the second base substrate facing the array substrate, and configured to prevent liquid crystal in the liquid crystal layer from overflowing,
wherein the liquid crystal display panel comprises a display region and a peripheral region surrounding the display region, and further comprises a frame sealing adhesive located in the peripheral region and disposed between the array substrate and the opposite substrate, and the anti-overflow structure surrounds the display region and is disposed on a side of the frame sealing adhesive close to the display region.

2. The liquid crystal display panel according to claim 1, wherein a maximum dimension of the display region of the liquid crystal display panel in a plane parallel to the second base substrate is less than or equal to 30 mm.

3. The liquid crystal display panel according to claim 1, wherein in a plane parallel to the second base substrate, a distance between the anti-overflow structure and the display region is in a range from 100 μm to 300 μm, a distance between the anti-overflow structure and the frame sealing adhesive is in a range from 100 μm to 300 μm.

4. The liquid crystal display panel according to claim 1, wherein the opposite substrate further comprises a spacer, and the spacer is located in the display region and disposed on a side of the second base substrate facing the array substrate,
the anti-overflow structure is configured to be formed by a same material and a same patterning process as the spacer.

5. The liquid crystal display panel according to claim 1, wherein the anti-overflow structure comprises at least one anti-overflow cofferdam.

6. The liquid crystal display panel according to claim 5, wherein a shape of an anti-overflow cofferdam of the at least one anti-overflow cofferdam in a plane parallel to the second base substrate comprises a polygon, and the anti-overflow cofferdam comprises a plurality of notches.

7. The liquid crystal display panel according to claim 5, wherein an anti-overflow cofferdam of the at least one anti-overflow cofferdam comprises a notch, the opposite substrate further comprises an alignment layer, and the alignment layer is disposed on a side of the second base substrate facing the array substrate and has an alignment direction,
the notch is located at a position of the anti-overflow cofferdam farthest from a center line passing through a center of the display region and along the alignment direction.

8. The liquid crystal display panel according to claim 5, wherein the at least one anti-overflow cofferdam comprises:
a first anti-overflow cofferdam, comprising a first opening; and
a second anti-overflow cofferdam, comprising a second opening,
wherein the first opening and the second opening are opposite to each other, and the first anti-overflow cofferdam and the second anti-overflow cofferdam have an overlapping region in which the first anti-overflow cofferdam and the second anti-overflow cofferdam are arranged at intervals to form a channel.

9. The liquid crystal display panel according to claim 8, wherein the opposite substrate further comprises an alignment layer, the alignment layer is disposed on a side of the second base substrate facing the array substrate and has an alignment direction,
the overlapping region is disposed on a position of the anti-overflow cofferdam farthest from a center line passing through a center of the display region and along the alignment direction.

10. The liquid crystal display panel according to claim 8, wherein the first anti-overflow cofferdam comprises a first sub-portion and a second sub-portion arranged opposite to each other, and a first connection portion connecting the first sub-portion and the second sub-portion, and the second anti-overflow cofferdam comprises a third sub-portion and a fourth sub-portion arranged opposite to each other, and a second connection portion connecting the third sub-portion and the fourth sub-portion,
the first sub-portion and the third sub-portion have an overlapping region and are arranged at intervals to form a channel, and the second sub-portion and the fourth sub-portion have an overlapping region and are arranged at intervals to form a channel.

11. The liquid crystal display panel according to claim 5, wherein an anti-overflow cofferdam of the at least one anti-overflow cofferdam comprises a plurality of first anti-overflow portions and a plurality of second anti-overflow portions, and a dimension of each of the plurality of first anti-overflow portions is larger than a dimension of each of the plurality of second anti-overflow portions in a direction perpendicular to the second base substrate,
in an extending direction of the anti-overflow cofferdam, the plurality of first anti-overflow portions and the plurality of second anti-overflow portions are alternately arranged.

12. (canceled)

13. The liquid crystal display panel according to claim 1, wherein the opposite substrate further comprises a planarization layer, the planarization layer is disposed on a side of the second base substrate facing the array substrate, and the anti-overflow structure comprises at least one anti-overflow groove formed in the planarization layer and recessed toward the second base substrate.

14. (canceled)

15. The liquid crystal display panel according to claim 1, wherein the opposite substrate further comprises:
an electrostatic discharge layer, disposed on a side of the second base substrate facing the array substrate,
wherein the frame sealing adhesive is at least partially connected with the electrostatic discharge layer, and the frame sealing adhesive is configured to have conductivity so that the electrostatic discharge layer is connected with the array substrate through the frame sealing adhesive.

16. The liquid crystal display panel according to claim 15, wherein the array substrate further comprises a common electrode layer, disposed on a side of the first base substrate facing the opposite substrate,
the common electrode layer comprises a common electrode located in the display region and a conductive structure located in the peripheral region, and the frame sealing adhesive is at least partially connected with the conductive structure.

17. The liquid crystal display panel according to claim 16, wherein the array substrate further comprises a first common electrode line surrounding the display region and a second common electrode line surrounding the first common electrode line, the first common electrode line is connected with the second common electrode line, the first common electrode line is connected with the common electrode, and the second common electrode line is connected with a signal input port of the liquid crystal display panel, the array substrate further comprises a via hole, and the second common electrode line is connected to the conductive structure through the via hole.

18. The liquid crystal display panel according to claim 17, wherein an orthogonal projection of the frame sealing adhesive on the first base substrate at least partially overlaps with an orthogonal projection of the second common electrode line on the first base substrate, the second common electrode line comprises a metal grid line.

19. The liquid crystal display panel according to claim 16, wherein the array substrate further comprises a first common electrode line surrounding the display region and a second common electrode line surrounding the first common electrode line, the first common electrode line is connected with the second common electrode line and connected with the common electrode of the display region, the second common electrode line is connected to a first signal input port of the liquid crystal display panel to be supplied with a first voltage signal,
the conductive structure is connected to a second signal input port of the liquid crystal display panel through a lead to be supplied with a second voltage signal.

20-21. (canceled)

22. The liquid crystal display panel according to claim 16, wherein the plurality of pixel structures are arranged along a first direction and a second direction, and the second direction intersects with the first direction,
in each of the plurality of pixel structures, the common electrode comprises a plurality of first slots extending along the first direction and arranged along the second direction,
the electrostatic discharge layer comprises a plurality of electrostatic discharge portions corresponding to the plurality of pixel structures, and each of the plurality of electrostatic discharge portions comprises a plurality of second slots extending along the first direction and arranged along the second direction.

23-25. (canceled)

26. The liquid crystal display panel according to claim 1, wherein the opposite substrate further comprises:
a black matrix layer, disposed on a side of the second base substrate facing the array substrate;
a color film layer, disposed on a side of the second base substrate facing the array substrate; and
a planarization layer, disposed on a side of both the black matrix layer and the color film layer facing the array substrate,
wherein the anti-overflow structure is disposed on a side of the planarization layer facing the array substrate.

27. A display device, comprising the liquid crystal display panel according to claim 1.
